(19) United States
(12) Patent Application Publication
(10) Pub. No.: US 2012/0033567 A1
(43) Pub. Date: Feb. 9, 2012

(54) DATA TRANSMISSION APPARATUS, DATA RECEIVING APPARATUS, AND DATA TRANSMISSION METHOD

(75) Inventors: Akiko Yamada, Kawasaki (JP); Satoshi Imai, Kawasaki (JP)

(73) Assignee: FUJITSU LIMITED, Kawasaki-shi (JP)

(21) Appl. No.: 13/154,586

(22) Filed: Jun. 7, 2011

(30) Foreign Application Priority Data
Aug. 5, 2010 (JP) 2010-176398

(51) Int. Cl. H04L 12/26

(52) U.S. Cl. 370/252

(57) ABSTRACT

In a data transmission apparatus a processor refers to a storage unit storing a usage percentage indicative of a percentage by which each of a plurality of routes is used for transmitting data destined for an apparatus, distributes the data destined for the apparatus to routes according to the usage percentage of each route to transmit the data destined for the apparatus, lowers the usage percentage set in the storage unit of a route on which a data transmission load is light compared with other routes to zero. If a state in which the usage percentages of two or more routes are greater than zero continues for a determined period of time, then the processor determines that an equilibrium state has arisen. Upon detecting the equilibrium state, the processor sets usage percentages of the two or more routes between which there is a difference in the storage unit.

### CROSS-REFERENCE TO RELATED APPLICATION

This application is based upon and claims the benefit of priority of the prior Japanese Patent Application No. 2010-176398, filed on Aug. 5, 2010, the entire contents of which are incorporated herein by reference.

### FIELD

The embodiments discussed herein are related to a data transmission apparatus, a data receiving apparatus, and a data transmission method for distributing traffic in a network, and a computer-readable medium storing a data transmission program.

### BACKGROUND

In networks, a plurality of nodes relay a packet and transmit it to a destination computer. Each node exchanges route information with another node in order to recognize a transmission route to the destination of the packet. The route information includes a transmission route which a node that sends the route information recognizes. Each node selects a packet destination on the basis of the route information received from another node.

If there are a plurality of transmission routes from a node to a destination computer, then the node performs route selection in accordance with a predetermined algorithm. A route selection algorithm used by each node is provided in a routing protocol such as OSPF (Open Shortest Path First) or RIP (Routing Information Protocol). With these routing protocols, basically route selection is performed so that the shortest route will be taken. Alternatively, the existing advanced control using these routing protocols is exercised. That is to say, smoothing is performed so that the peak of the usage percentage of a network will be minimized. At the same time route selection is performed so that the shortest route will be taken.

If the above conventional routing protocols are used, traffic (data which moves in a network), such as a packet, is transmitted along a predetermined route. Accordingly, even when a traffic volume is low throughout a network, it is necessary to continue starting each node.

With the improvement of network throughput, on the other hand, the consumption of power by devices included in networks has increased. Therefore, operation which controls the power consumption of an entire network is important. Accordingly, for example, the following technique is proposed. A highway on which a traffic volume is low is detected automatically and data on the highway is automatically made to flow along another highway. By doing so, a device in an electronic switching system goes into an unused state. Control is exercised so that the power to the device will be shut off. As a result, power consumption can be reduced. Furthermore, the following technique is proposed. If a traffic volume is low in an autonomous distributed route control system which does not use a centralized management and control apparatus, then traffic is centralized on a route on which a traffic volume is higher. By doing so, many free nodes are generated.

Conversely, a technique for distributing traffic in the case of traffic congestion being ready to occur is known. For example, a plurality of routes of paths are defined in advance between an entry node and an exit node of a network. If the usage percentage of a link connected to each node exceeds a threshold, it transmits information referred to as an adjuster to the entry node. The entry node changes the probability of using a path for which the adjuster is received, and exercises control to prevent congestion.

Japanese Laid-open Patent Publication No. 2001-119730

Akiko Yamada, et al., “A Study for Green Network (3): ECO Routing”, Proceedings of the IECE General Conference, The Institute of Electronics, Information and Communication Engineers (IEICE), Mar. 4, 2009, 2009_communication (2), pp. 252.

Akiko Yamada, et al., “A New Path-based Traffic Control Method for Network Power Saving”, The Institute of Electronics, Information and Communication Engineers (IEICE), IEICE Technical Report, vol. 109, no. 448, March 2010, NS2009-232, pp. 393-398.

With the autonomous distributed route control system, however, the following problem arises. When stabilization is effected in an equilibrium state (balanced state) in which the volume of traffic on a plurality of routes is the same, it is difficult to realize proper traffic centralization. For example, if the volume of entire traffic decreases after distributing traffic for preventing congestion, traffic on a plurality of routes may stabilize in an equilibrium state.

### SUMMARY

According to one aspect of the present invention, a data transmission apparatus for transmitting data a destination of which is an apparatus connected thereto via a network via any of a plurality of routes in the network includes a plurality of communication interfaces corresponding to the plurality of routes; a storage unit configured to store a usage percentage indicative of a percentage by which each of the plurality of routes is used for transmitting the data the destination of which is the apparatus; and a processor configured: to refer to the storage unit and to distribute the data the destination of which is the apparatus to routes according to the usage percentage of each route to transmit the data the destination of which is the apparatus; to lower the usage percentage of a route on which a data transmission load is light compared with other routes, the usage percentage being set in the storage unit; to determine, in the case of a state in which the usage percentages of two or more routes are greater than a determined value continuing for a determined period of time, that an equilibrium state has arisen; and to set usage percentages of the two or more routes between which there is a difference in the storage unit in the case of the determination that an equilibrium state has arisen being made.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a data transmission apparatus according to a first embodiment;

FIG. 2 illustrates an example of the structure of a system according to a second embodiment;

FIG. 3 illustrates an example of the hardware configuration of a node used in the second embodiment;

FIG. 4 illustrates an example of centralization control;

FIG. 5 illustrates an example of congestion suppression control;

FIG. 6 illustrates an example of the occurrence of a traffic equilibrium state;

FIG. 7 illustrates an example of equilibrium cancellation control;

FIG. 8 illustrates the functions of each node;

FIG. 9 illustrates an example of the data structure of a traffic control information storage unit;

FIG. 10 illustrates an example of the detailed structure of a transmission probability management unit in the second embodiment;

FIG. 11 illustrates an example of the data structure of a traffic storage unit;

FIG. 12 illustrates an example of the data structure of an equilibrium information storage unit;

FIG. 13 is a flow chart of a procedure for an equilibrium determination process;

FIG. 14 is a flow chart of a procedure for an equilibrium cancellation determination process;

FIG. 15 is a flow chart of a procedure for an equilibrium cancellation process;

FIG. 16 illustrates an example of a state in which traffic is distributed;

FIG. 17 illustrates examples of an equilibrium management table at the time of the determination that sections are in an equilibrium state being made;

FIG. 18 illustrates an example of a change in transmission probability made by one node;

FIG. 19 illustrates a state after a change in transmission probability based on attraction;

FIG. 20 illustrates a state in which centralization has progressed;

FIG. 21 illustrates an example of the structure of a system according to a third embodiment;

FIG. 22 is a block diagram of the functions of a node in the third embodiment;

FIG. 23 illustrates an example of the data structure of an operation definition storage unit;

FIG. 24 illustrates an example of an equilibrium state in the third embodiment;

FIG. 25 illustrates the contents of a traffic control table of each entry node at the time of traffic being in an equilibrium state;

FIG. 26 is a sequence diagram of an example of a procedure for an equilibrium cancellation process in the third embodiment;

FIG. 27 is an example of an equilibrium notice message transmitted from an entry node to an exit node;

FIG. 28 is an example of a response message;

FIG. 29 indicates a state in which a node the node ID of which is “1” has changed transmission probabilities;

FIG. 30 illustrates a traffic volume on each link after the change in transmission probability made by the node the node ID of which is “1”;

FIG. 31 illustrates a traffic volume on each link after a change in transmission probability made by each of nodes the node ID of which are “2,” “3,” “4,” and “5”;

FIG. 32 is a view for describing an accommodable remaining volume;

FIG. 33 is a block diagram of the functions of a node in a fourth embodiment;

FIG. 34 is an example of a state notice control packet;

FIG. 35 illustrates an example of the data structure of an accommodable remaining volume storage unit;

FIG. 36 is a sequence diagram of an example of a procedure for an equilibrium cancellation process in the fourth embodiment;

FIG. 37 is an example of an equilibrium notice message transmitted from an entry node to an exit node; and

FIG. 38 is an example of a response message in the fourth embodiment.

### DESCRIPTION OF EMBODIMENTS

Embodiments will now be described with reference to the accompanying drawings.

### First Embodiment

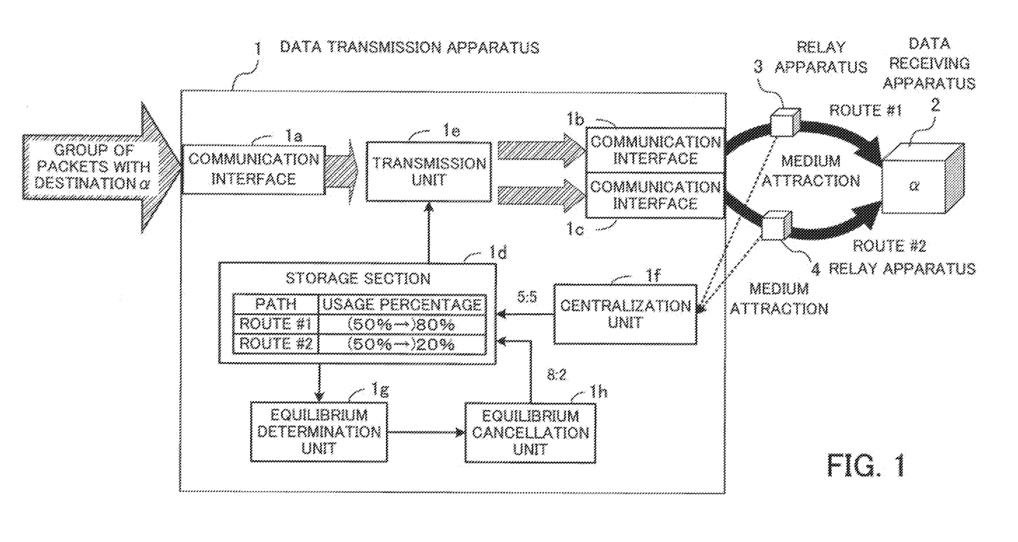

FIG. 1 is a block diagram of a data transmission apparatus according to a first embodiment. Data the destination of which is a data receiving apparatus 2 is inputted to a data transmission apparatus 1 via a communication interface 1a. In addition, the data transmission apparatus 1 includes two communication interfaces 1b and 1c connected to routes to the data receiving apparatus 2. In the example of FIG. 1, the communication interface 1b is connected to a route along which data is transmitted to the data receiving apparatus 2 via a relay apparatus 3. The communication interface 1c is connected to a route along which data is transmitted to the data receiving apparatus 2 via a relay apparatus 4. It is assumed that a path through the relay apparatus 3 is the “route #1” and that a path through the relay apparatus 4 is the “route #2”.

In order to transmit data which is inputted via the communication interface 1a and the destination of which is the data receiving apparatus 2, the data transmission apparatus 1 includes a storage unit 1d, a transmission unit 1e, a centralization unit 1f, an equilibrium determination unit 1g, and an equilibrium cancellation unit 1h.

The storage unit 1d stores a usage percentage indicative of a percentage by which each of the plurality of routes is used for transmitting data the destination of which is the data receiving apparatus 2. For example, a percentage of all transmitted data which is transmitted by the use of each route is indicated as a transmission probability in the storage unit 1d.

The transmission unit 1e refers to the storage unit 1d and distributes the data the destination of which is the data receiving apparatus 2 to the plurality of routes according to the usage percentage of each route to transmit it. For example, the transmission unit 1e transmits 50 percent of all transmitted data the destination of which is the data receiving apparatus 2 via a route for which a transmission probability of 50 percent is set.

The centralization unit 1f lowers the usage percentage of a route on which a data transmission load is light compared with the other routes. This usage percentage is set in the storage unit 1d. For example, the centralization unit 1f acquires attraction values which become larger with an increase in the amount of data transmitted via the routes from the relay apparatus 3 and 4 adjacent thereto on the routes as indexes indicative of loads on the routes. According to a calculation formula used for calculating an attraction value of a route, the attraction value increases more greatly than the amount of data transmitted via the route. That is to say, the attraction value is obtained by amplifying the degree of an increase in the amount of data transmitted via the route, and reflects a load on the route. For example, if the amount of data which flows along the route increases by 10 percent, the attraction value of the route increases by more than 10 percent. As a result, if there is a difference between the usage percentages of the routes, then the centralization unit 1f gradually increases the usage percentage of a route via which a larger amount of data is transmitted, and gradually decreases the usage percentage of the other route. For example, the centralization unit 1f finally sets the usage percentage of each route to 0 except one route. By doing so, data transmission can be centralized on one route.

If a state in which there are a plurality of routes of which the usage percentages regarding transmission of data the destination of which is the data receiving apparatus 2 are greater than a determined value continues for a determined period of time, then the equilibrium determination unit 1g determines that transmission of the data the destination of which is the data receiving apparatus 2 is in an equilibrium state. A value greater than or equal to 0 percent and smaller than 50 percent is set as the determined value for a usage percentage. For example, 0 is set as the determined value. For example, if transmission probabilities for the two routes are both 50 percent, then the amount of data transmitted via each route is the same. Accordingly, a transmission probability for each route which the centralization unit 1f sets in the storage unit 1d is “50 percent”. In this case, the usage percentage of each route is “50 percent” and is stable. That is to say, a state in which there are a plurality of routes of which the usage percentages are greater than the determined value continues for the determined period of time. As a result, the determination that transmission of the data the destination of which is the data receiving apparatus 2 is in an equilibrium state is made.

If the determination that transmission of the data the destination of which is the data receiving apparatus 2 is in an equilibrium state is made, then the equilibrium cancellation unit 1h sets usage percentages of the plurality of routes between which there is a difference in the storage unit 1d. For example, the equilibrium cancellation unit 1h sets a transmission probability for one route (route #1) to 80 percent and sets a transmission probability for the other route (route #2) to 20 percent.

Even when the usage percentage of each route goes into an equilibrium state, the equilibrium cancellation unit 1h of the above data transmission apparatus 1 sets usage percentages of the routes between which there is a difference. As a result, there is also a difference between the amounts of data transmitted by the transmission unit 1e via the routes. The degree of the difference between the amounts of data transmitted via the routes is amplified. Attraction values are calculated by the relay apparatus 3 and 4 and are passed to the centralization unit 1f. The centralization unit 1f then raises the degree of the difference between the amounts of data transmitted via the routes. After that, the centralization unit 1f repeats raising the degree of the difference between the amounts of data transmitted via the routes corresponding to the attraction values. By doing so, transmission of data the destination of which is the data receiving apparatus 2 is centralized on a single route.

When data transmission goes into an equilibrium state, the equilibrium cancellation unit 1h can change the equilibrium state in this way. Traffic can be centralized by autonomous control.

If the equilibrium determination unit 1g determines that transmission of data the destination of which is the data receiving apparatus 2 is in an equilibrium state and a symptom of congestion is not detected on any of the plurality of routes, then the equilibrium cancellation unit 1h can set a difference between percentages by which data is sent out to the plurality of routes. By doing so, congestion suppression control is exercised in preference to equilibrium cancellation control and the reliability of a network can be increased.

In addition, the equilibrium cancellation unit 1h can determine wait time from the time when the determination that transmission of data the destination of which is the data receiving apparatus 2 is in an equilibrium state is made, and set a difference between percentages by which the data is sent out to the plurality of routes after the elapse of the wait time. For example, the equilibrium cancellation unit 1h sets time generated at random as wait time. If not only the data transmission apparatus 1 but also another apparatus that transmits data the destination of which is the data receiving apparatus 2 goes into an equilibrium state, this prevents the plurality of apparatus from changing data transmission percentages at the same time. That is to say, if the plurality of apparatus significantly change data transmission percentages at the same time, then the risk of the occurrence of congestion in the network increases. By changing data transmission percentages at different points of time, congestion can be prevented.

When transmission of data the destination of which is the data receiving apparatus 2 goes into an equilibrium state, the equilibrium cancellation unit 1h may give the data receiving apparatus 2 notice that transmission of the data the destination of which is the data receiving apparatus 2 is in an equilibrium state, and determine wait time according to the contents of a response to the notice from the data receiving apparatus 2. For example, a plurality of apparatus (equilibrium state apparatus) give the data receiving apparatus 2 notice that an equilibrium state has arisen. The ranking of the plurality of apparatus (equilibrium state apparatus) is performed on the basis of the volume of traffic the destination of which is the data receiving apparatus 2. The equilibrium cancellation unit 1h acquires the rank of the data transmission apparatus 1 from the data receiving apparatus 2. The equilibrium cancellation unit 1h can determine wait time according to the rank acquired. Determining wait time in this way on the basis of information acquired from the data receiving apparatus 2 can prevent setting the same wait time for a plurality of equilibrium state apparatus. This prevents a plurality of apparatus from changing data transmission percentages at the same time, and prevents congestion. Furthermore, By giving notice of information regarding ranking on the basis of a traffic volume, control can be exercised so that equilibrium cancellation operation will be performed in descending or ascending order of traffic volume. If equilibrium cancellation operation is performed in descending order of traffic volume, then there is a strong possibility that a balance can be destroyed rapidly. If equilibrium cancellation operation is performed in ascending order of traffic volume, then the risk of deterioration in quality caused by the occurrence of congestion or the like can be reduced. Proper order in which equilibrium cancellation operation is performed can be determined according to reliability or the necessity of power saving necessary to the network.

In addition, if after the arising of an equilibrium state the difference between percentages by which data the destination of which is the data receiving apparatus 2 is sent out to the plurality of routes is greater than or equal to a determined value, then the equilibrium determination unit 1g can determine that the equilibrium state is canceled. If the equilibrium determination unit 1g determines that transmission of data the destination of which is the data receiving apparatus 2 is in an equilibrium state and the equilibrium state is not canceled before the elapse of wait time, then the equilibrium cancellation unit 1h sets a difference between percentages by which the data is sent out to the plurality of routes. By doing so, congestion caused by performing unnecessary equilibrium cancellation operation can be prevented.

Moreover, the equilibrium cancellation unit 1h may give the data receiving apparatus 2 notice that transmission of data the destination of which is the data receiving apparatus 2 is in an equilibrium state, and determine the degree of the difference between percentages by which the data is sent out to the plurality of routes according to the contents of a response to the notice from the data receiving apparatus 2. For example, a plurality of equilibrium state apparatus give the data receiving apparatus 2 notice that an equilibrium state has arisen. The ranking of the plurality of equilibrium state apparatus is performed on the basis of the volume of traffic the destination of which is the data receiving apparatus 2. The equilibrium cancellation unit 1h acquires the rank of the data transmission apparatus 1 from the data receiving apparatus 2. The equilibrium cancellation unit 1h then determines the degree of the difference between the usage percentages of the plurality of routes according to the rank acquired. The degree of the difference between the usage percentages of the plurality of routes is determined in this way on the basis of information acquired from the data receiving apparatus 2. This makes it possible to set a proper degree of the difference by which traffic can be centralized in a short period of time, while preventing congestion.

When the equilibrium cancellation unit 1h determines the degree of the difference between usage percentages, the equilibrium cancellation unit 1h can use information regarding related apparatus of a plurality of equilibrium state apparatus each of which transmits data to the data receiving apparatus 2 via a route at least a part of which is included in a plurality of routes used by the data transmission apparatus 1. For example, the equilibrium cancellation unit 1h acquires the rank of the data transmission apparatus 1 obtained by performing the ranking of the related apparatus on the basis of the volume of traffic the destination of which is the data receiving apparatus 2 and the number of the related apparatus for the data transmission apparatus 1 from the data receiving apparatus 2. The equilibrium cancellation unit 1h then determines the degree of the difference between the usage percentages of the plurality of routes according to the rank of the data transmission apparatus 1 and the number of the related apparatus acquired. If the number of the related apparatus is large, the determination that the influence of a change in usage percentage made by the data transmission apparatus 1 on the entire network is slight can be made. Accordingly, if the number of the related apparatus is large, a rather high degree of difference between the usage percentages is set at change time. By doing so, traffic can be centralized early.

### Second Embodiment

A second embodiment will now be described. In the first embodiment a data transmission technique has been described. In many networks, however, data transmission is performed by the use of packets. Therefore, in the second embodiment a proper technique for distributing packets to transmission routes will be described with the case where packets are transmitted by routers arranged in a network as an example. In the following description a router which transmits a packet in a network will be referred to as a node.

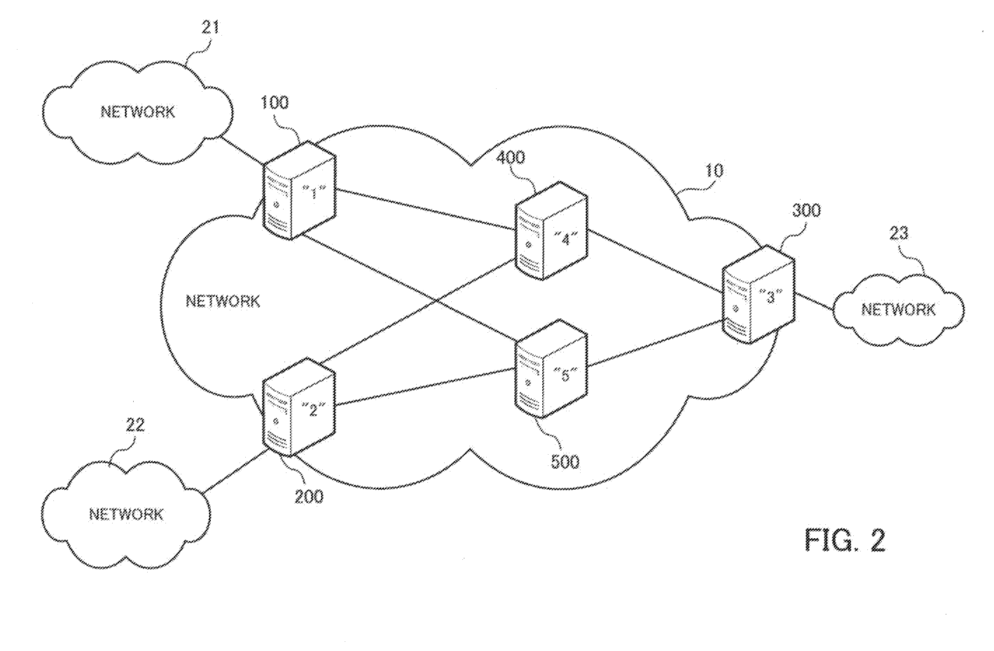

FIG. 2 illustrates an example of the structure of a system according to the second embodiment. A network 10 includes nodes 100, 200, 300, 400, and 500.

Of the nodes included in the network 10, the nodes 100, 200, and 300 are connected to networks 21, 22, and 23 respectively. Each of the nodes 100, 200, and 300 functions as a node for not only transmitting traffic in the network 10 but also transmitting traffic inputted from or outputted to another network. The nodes 100, 200, and 300 which transmit traffic to or from another network are specially referred to as edge nodes.

Of the edge nodes, a node which transmits traffic that flows in from another network via the network 10 is referred to as an entry node. Of the edge nodes, a node which sends out traffic transmitted thereto via the network 10 to another network is referred to as an exit node. An exit node also functions as the data receiving apparatus 2 illustrated in FIG. 1. An edge node functions as an entry node or an exit node, depending on the direction in which traffic is transmitted.

Of the nodes included in the network 10, the nodes 400 and 500 transmit traffic in the network 10. The nodes 400 and 500 which transmit traffic in the network 10 are specially referred to as relay nodes. Both the nodes 400 and 500 are connected to the nodes 100, 200, and 300. The nodes 400 and 500 transmit traffic between the nodes 100, 200, and 300.

ID for identifying each node in the network 10 is given thereto. The ID of the node 100 is “1”. The ID of the node 200 is “2”. The ID of the node 300 is “3”. The ID of the node 400 is “4”. The ID of the node 500 is “5”.

In the network 10 each node selects a transmission route, for example, in packets. A node which functions as an edge node also functions as a relay node for relaying a packet in the network 10.

When the inflow of traffic stops for a certain period of time, each node enters sleep mode. In the sleep mode, many functions of a node stop and power consumption is kept low. Even in the sleep mode, however, functions necessary for transmitting a control packet are kept on. The sleep mode is an example of a power-saving mode. For example, when the inflow of traffic into a node stops for a certain period of time, the node can be made to enter low power mode as the power-saving mode in which an operating frequency is low.

By adopting the structure illustrated in FIG. 2, traffic is transmitted in the network 10. In the second embodiment it is assumed that traffic which flows into the node 100 or 200 is transmitted to the node 300. Traffic which flows into the network is transmitted to the node 300, which is an exit, along a route defined in advance in the node 100 or 200, which is an entry. A route along which traffic is transmitted from an entry node to an exit node is referred to as a “path”. In the second embodiment the node 100 or 200 at which traffic flows in from the network 21 or 22 functions as an entry node. The node 300 at which traffic is sent out to the network 23 functions as an exit node. The node 400 or 500 which relays traffic in the network 10 functions as a relay node. The node 100 or 200 which functions as an entry node distributes traffic which flows in to preset paths with determined transmission probabilities.

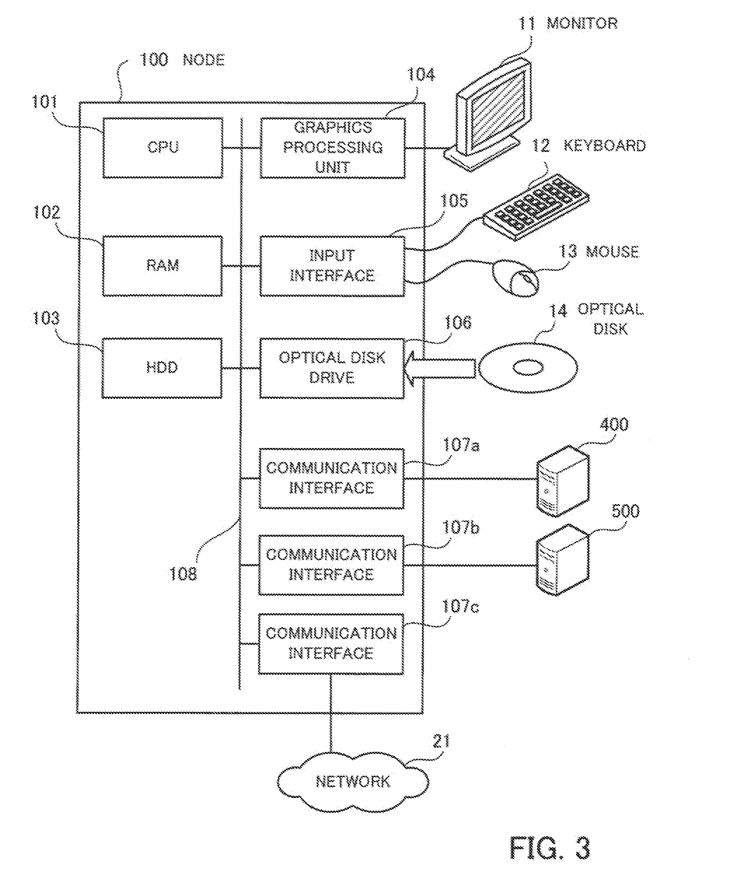

FIG. 3 illustrates an example of the hardware configuration of a node used in the second embodiment. The whole of the node 100 is controlled by a central processing unit (CPU) 101. A random access memory (RAM) 102 and peripheral devices are connected to the CPU 101 via a bus 108.

The RAM 102 is used as main storage of the node 100. The RAM 102 temporarily stores at least part of an operating system (OS) or an application program executed by the CPU 101. The RAM 102 also stores various pieces of data which the CPU 101 needs to perform a process.

The peripheral devices connected to the bus 108 include HDD (Hard Disk Drive) 103, a graphics processing unit 104, an input interface 105, an optical disk drive 106, and communication interfaces 107a, 107b, and 107c.

The HDD 103 magnetically writes data to and reads out data from a built-in disk. The HDD 103 is used as auxiliary storage of the node 100. The HDD 103 stores the OS, application programs, and various pieces of data. A semiconductor memory such as a flash memory can be used as auxiliary storage.

A monitor 11 is connected to the graphics processing unit 104. In accordance with instructions from the CPU 101, the graphics processing unit 104 displays an image on a screen of the monitor 11. A display unit using a CRT (Cathode Ray Tube), a liquid crystal display, or the like is used as the monitor 11.

A keyboard 12 and a mouse 13 are connected to the input interface 105. The input interface 105 sends a signal sent from the keyboard 12 or the mouse 13 to the CPU 101. The mouse 13 is an example of a pointing device and another pointing device such as a touch panel, a tablet, a touch pad, or a track ball can be used.

The optical disk drive 106 reads data recorded on an optical disk 14 by the use of, for example, a laser beam. The optical disk 14 is a portable record medium on which data is recorded so that it can be read by the reflection of light. The optical disk 14 may be a DVD (Digital Versatile Disk), a DVD-RAM, a CD-ROM (Compact Disk Read Only Memory), a CD-R (Recordable)/RW (ReWritable), or the like.

The communication interface 107a is connected to the node 400. The communication interface 107a sends data to and receives data from the node 400. The communication interface 107b is connected to the node 500. The communication interface 107b sends data to and receives data from the node 500. The communication interface 107c is connected to the network 21. The communication interface 107c sends and receives data via the network 21.

By adopting the above hardware configuration, the processing functions of the second embodiment can be realized. FIG. 3 illustrates an example of the hardware configuration of the node 100. However, the other nodes 200, 300, 400, and 500 can also be realized by the same hardware configuration.

The nodes 100, 200, 300, 400, and 500 included in the above system exercise centralization control, congestion suppression control, and equilibrium cancellation control in cooperation with one another.

The centralization control will be described first.

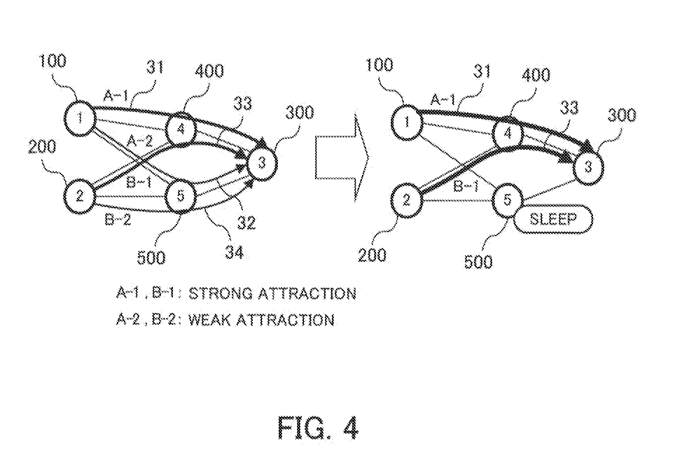

FIG. 4 illustrates an example of centralization control. In the example of FIG. 4, it is assumed that traffic which flows into the nodes 100 and 200 is transmitted to the node 300. With the centralization control in the second embodiment attraction of paths via which the nodes 100 and 200 that function as entry nodes transmit packets is set. Attraction is a value for promoting the centralization of traffic transmitted in a network. A higher traffic volume is assigned to a path the attraction of which is larger.

In the example of FIG. 4, a path 31 through the node 400 and a path 32 through the node 500 are set in the node 100 as paths for traffic the destination of which is the node 300. The identifiers of the paths 31 and 32 are “A-1” and “A-2” respectively. In addition, a path 33 through the node 400 and a path 34 through the node 500 are set in the node 200 as paths for traffic the destination of which is the node 300. The identifiers of the paths 33 and 34 are “B-1” and “B-2” respectively.

In the example of FIG. 4, a traffic volume on each of the paths 31 through 34 is represented by the thickness of an arrow which indicates it. That is to say, a traffic volume on the path 31 is higher than a traffic volume on the path 32 and a traffic volume on the path 33 is higher than a traffic volume on the path 34.

Each of the nodes 100 and 200 sets attraction of each path so that attraction of a path on which a traffic volume is higher will become larger. Accordingly, the node 100 makes attraction of the path 31 the identifier of which is “A-1” larger than attraction of the path 32 the identifier of which is “A-2”. Similarly, the node 200 makes attraction of the path 33 the identifier of which is “B-1” larger than attraction of the path 34 the identifier of which is “B-2”.

A high traffic volume is assigned to a path the attraction of which is large. As a result, the attraction of the path becomes larger. With the elapse of time, the degree of traffic centralization is enhanced. Finally, traffic is centralized on the paths 31 and 33.

Traffic is centralized on the paths the attraction of which is large, so the node 500 does not transmit traffic. The node 500 which does not transmit traffic detects that no traffic flows in, and enters sleep mode.

With the centralization control, by the way, traffic is centralized on a specific path. As a result, if the volume of entire traffic increases, congestion is apt to occur on the path on which traffic is centralized. Accordingly, control for suppressing congestion is exercised. The congestion suppression control will now be described.

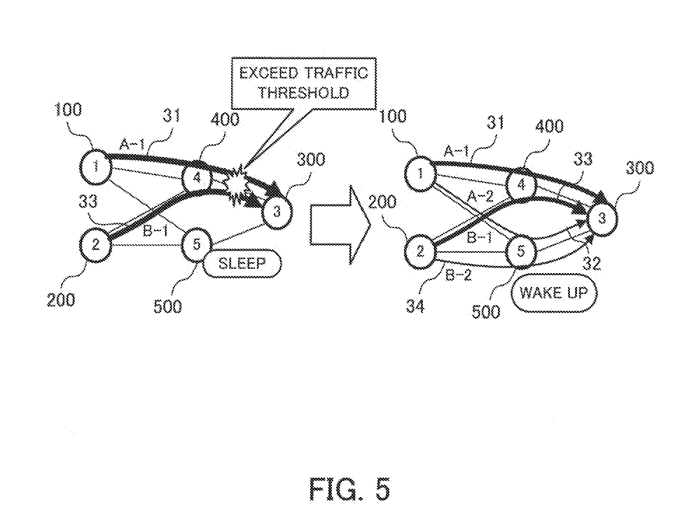

FIG. 5 illustrates an example of the congestion suppression control. With the congestion suppression control a traffic volume is measured for each link between nodes. A link is a transmission line between adjacent nodes. For example, each node measures the volume of traffic sent out to links it has. A traffic threshold for detecting a symptom of congestion is set according to link of each node. This threshold is designated, for example, by a traffic volume to a link bandwidth (usage percentage). A usage percentage is a value obtained, for example, by dividing a traffic volume by a link bandwidth. If the usage percentage of a link each node has exceeds a threshold, it generates an alarm. A node which generates an alarm transmits alarm information to an entry node of a path including the link the usage percentage of which exceeds the threshold.

In the example of FIG. 5, a traffic volume exceeds a threshold on a link between the nodes 400 and 300. In this case, the node 400 generates an alarm and transmits alarm information to the nodes 100 and 200.

Each of the entry nodes 100 and 200 which receive the alarm information distributes traffic the destination of which is the node 300 and which is transmitted via a path including the link for which the node 400 generates the alarm to a plurality of paths. Accordingly, there is traffic transmitted via the node 500 which is in sleep mode. As a result, the node 500 starts (wakes up) and begins to transmit a packet.

It is not necessary for each of the nodes 100 and 200 which distribute traffic in response to the alarm to distribute the traffic equally. That is to say, each of the nodes 100 and 200 may distribute the traffic with a certain degree of difference maintained. For example, the node 100 sets the probability of transmitting traffic to the path 31 to “80%” and sets the probability of transmitting traffic to the path 32 to “20%”. Traffic on each path may go into an equilibrium state due to the congestion suppression control. However, this can prevent traffic on each path from going into an equilibrium state.

However, even when control is exercised for preventing traffic on each path from going into an equilibrium state, it is inevitable in some cases that traffic on each path will go into an equilibrium state.

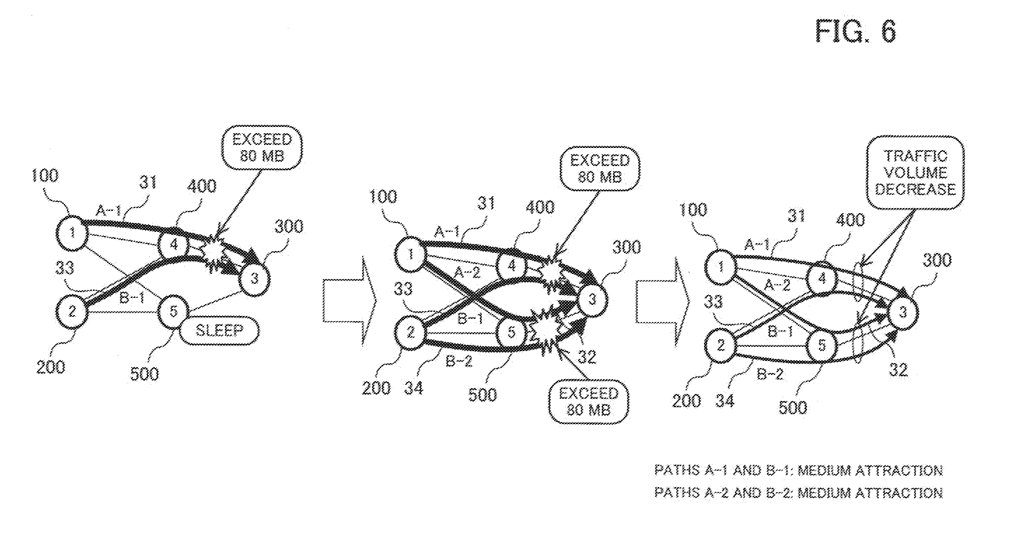

FIG. 6 illustrates an example of the occurrence of a traffic equilibrium state. In the example of FIG. 6, it is assumed that the traffic capacity of each link is 100 MB and that the traffic threshold of each link is 80 MB. In addition, it is assumed that traffic from the node 100 to the node 300 is centralized on the path 31 and that traffic from the node 200 to the node 300 is centralized on the path 33.

When a traffic volume on the link from the node 400 to the node 300 exceeds 80 MB, the node 400 generates an alarm and congestion suppression control is begun. The node 400 repeats transmission of alarm information until a traffic volume on the link from the node 400 to the node 300 becomes smaller than or equal to a determined value. The nodes 100 and 200 distribute traffic in response to the generation of the alarm. At this time it is assumed that the volume of traffic which flows into the node 100 and the destination of which is the node 300 exceeds 80 MB and that the volume of traffic which flows into the node 200 and the destination of which is the node 300 exceeds 80 MB. In this case, a traffic volume on a link from the node 500 to the node 100 also exceeds the threshold. The traffic capacity of each link is the same, so the nodes 100 and 200 distribute traffic equally to the paths 31 through 34 and transmit as much traffic as possible. As a result, a traffic volume on the path 31 from the node 100 to the node 300 becomes equal to a traffic volume on the path 32 from the node 100 to the node 300 and an equilibrium state arises. Similarly, a traffic volume on the path 33 from the node 200 to the node 300 becomes equal to a traffic volume on the path 34 from the node 200 to the node 300 and an equilibrium state arises. When a traffic volume is in an equilibrium state, the attraction of each path is the same.

Accordingly, even if the volume of traffic which flows into the nodes 100 and 200 decreases later, the attraction of each path remains the same. With the centralization control traffic is centralized on a path the attraction of which is strong. When the attraction of each path is the same, it is impossible to centralize traffic on a specific path. That is to say, once an equilibrium state arises, it cannot be canceled only by the traffic centralization control based on attraction.

Therefore, when an equilibrium state arises, equilibrium cancellation control is exercised.

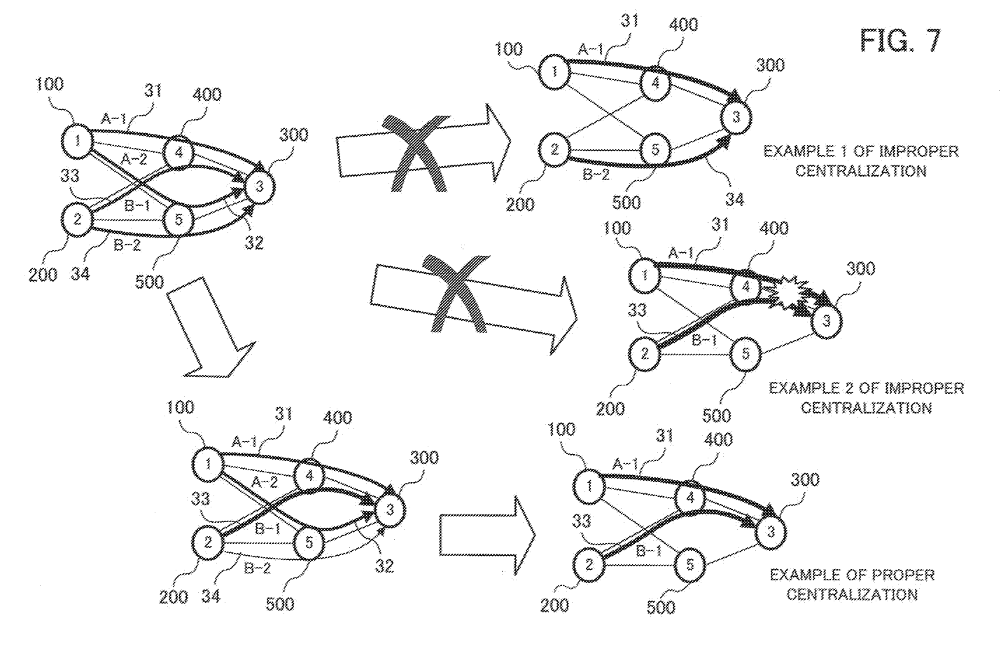

FIG. 7 illustrates an example of the equilibrium cancellation control. There are cases where traffic centralization by which a node can enter sleep mode cannot be performed only by changing an equilibrium state. In addition, there are cases where a rapid increase in the volume of traffic on a link causes congestion and a serious deterioration in quality.

In an “improper example 1 of centralization”, the node 100 centralizes traffic on the path 31 and the node 200 centralizes traffic on the path 34. As a result, the node 400 relays traffic on the path 31 and the node 500 relays traffic on the path 34. Accordingly, no node can enter sleep mode.

In an “improper example 2 of centralization”, the node 100 centralizes traffic on the path 31 at a stretch. At the same time the node 200 centralizes traffic on the path 33 at a stretch. As a result, a traffic volume on the link from the node 400 to the node 300 increases sharply and congestion occurs. The occurrence of congestion causes packet loss or the like and a deterioration in quality in the entire network.

Therefore, in the second embodiment there is a node which can enter sleep mode, and an equilibrium state is canceled without causing a rapid increase in the volume of traffic.

In a “proper example of centralization”, the nodes 100 and 200 begin at different points of time to centralize traffic. Furthermore, the nodes 100 and 200 centralize the traffic not at a stretch but gradually. In the example of FIG. 7, the node 200 centralizes the traffic first. In the initial stages the node 200 sets the probability of transmitting traffic to the path 33 to a value (80 percent, for example) greater than 50 percent and sets the probability of transmitting traffic to the path 34 to a value (20 percent, for example) smaller than 50 percent. At this time the node 200 does not set the probability of transmitting traffic to one path to “100 percent” at a stretch. After that, traffic is distributed according to attraction by the centralization control. As a result, traffic is centralized with the elapse of time unless there is a link on which a traffic volume exceeds a threshold. In the example of FIG. 7, traffic which flows into the node 100 is centralized on the path 31 and traffic which flows into the node 200 is centralized on the path 33.

In the second embodiment, as has been described, a mechanism which performs equilibrium cancellation at proper timing to a moderate degree in the case of traffic the destination of which is a node going into an equilibrium state is realized. The functions of each node in the second embodiment will now be described.

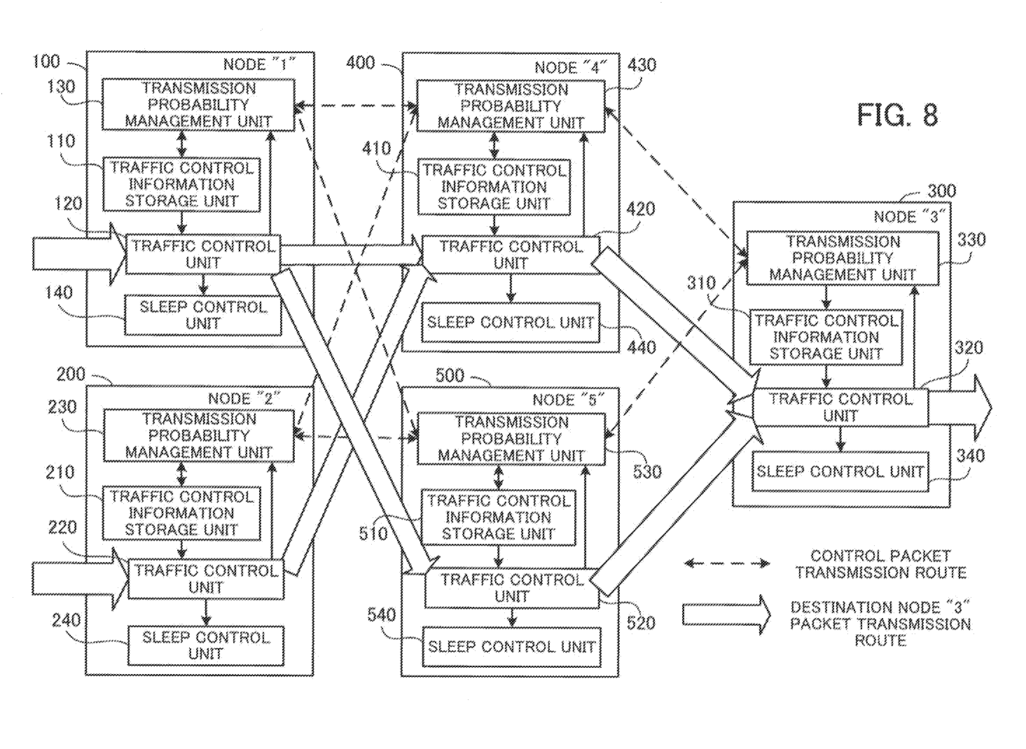

FIG. 8 illustrates the functions of each node. The node 100 includes a traffic control information storage unit 110, a traffic control unit 120, a transmission probability management unit 130, and a sleep control unit 140.

The traffic control information storage unit 110 stores paths for traffic which flows into the node 100 according to destination, a transmission probability for each path, and the like. For example, a part of a storage area of the RAM 102 or the HDD 103 is used as the traffic control information storage unit 110. When the node 100 functions as a relay node, route information for paths which run through the node 100 can be registered in the traffic control information storage unit 110. In this case, the traffic control unit 120 reads out a path corresponding to a destination of a packet to be relayed from the traffic control information storage unit 110. The traffic control unit 120 can recognize a packet transmission route on the basis of a route of the path read out.

The traffic control unit 120 relays a packet inputted. When the node 100 functions as an entry node, the traffic control unit 120 refers to the traffic control information storage unit 110 and determines a node to which the packet is transmitted according to a transmission probability for a path corresponding to a destination of the packet inputted. While congestion suppression control is being exercised over traffic transmitted to an exit node which is the destination, the traffic control unit 120 assigns, for example, a traffic volume by which traffic exceeds a capacity limit on a link on which congestion has occurred to another link. When the node 100 functions as a relay node, the traffic control unit 120 reads out a path corresponding to a destination of a packet inputted from the traffic control information storage unit 110 and transmits the packet to an adjacent node on the exit node side on a route of the path.

The transmission probability management unit 130 manages a transmission probability for a path. To be concrete, the transmission probability management unit 130 exchanges control packets with a transmission probability management unit 430 of the node 400 or a transmission probability management unit 530 of the node 500. A control packet includes the attraction of each node, alarm information generated in the case of a symptom of congestion being detected, and the like. When transmission probability management unit 130 exercises centralization control, the transmission probability management unit 130 calculates the attraction of each path on the basis of the attraction of the nodes 400 and 500 and the situation of traffic distribution by the traffic control unit 120. The transmission probability management unit 130 then calculates a transmission probability for a path on the basis of its attraction and stores the transmission probability in the traffic control information storage unit 110.

In addition, when the transmission probability management unit 130 acquires alarm information from the node 400 or 500, the transmission probability management unit 130 stops the centralization control and begins congestion suppression control. When the transmission probability management unit 130 exercises congestion suppression control, the transmission probability management unit 130 determines a transmission probability for each path so as to distribute a part of traffic transmitted via a path including a link on which a traffic volume exceeds a threshold to paths exit nodes of which are the same as an exit node of the path. The transmission probability management unit 130 then stores the determined transmission probability for each path in the traffic control information storage unit 110.

Furthermore, on the basis of the situation of traffic distribution by the traffic control unit 120, the transmission probability management unit 130 detects the arising of an equilibrium state between a plurality of paths exit nodes of which are the same. If an equilibrium state arises, the transmission probability management unit 130 exercises equilibrium cancellation control over the plurality of paths between which an equilibrium state has arisen. When the transmission probability management unit 130 exercises equilibrium cancellation control, the transmission probability management unit 130 generates a random value and determines wait time on the basis of the random value. If the equilibrium state is not changed after the elapse of the wait time, then the transmission probability management unit 130 determines the transmission probability of each path so that there will be a difference in traffic volume between the plurality of paths. The transmission probability management unit 130 then stores the determined transmission probability for each path in the traffic control information storage unit 110.

The sleep control unit 140 controls a shift to sleep mode and the return from sleep mode to normal mode. For example, the sleep control unit 140 monitors traffic control by the traffic control unit 120 and gauges time which elapses after the last traffic handling. When the time which elapses after the last traffic handling exceeds sleep mode shift time set in advance, the sleep control unit 140 makes the node 100 enter sleep mode. When the sleep control unit 140 receives from another node a message which gives it instructions to make the node 100 enter sleep mode, the sleep control unit 140 also makes the node 100 enter sleep mode. In sleep mode the functions of the traffic control unit 120 and the like are stopped except, for example, the control packet transmission and receiving function of the transmission probability management unit 130. In addition, when the communication interface 107a, 107b, or 107c receives a packet at sleep mode time, the sleep control unit 140 cancels sleep mode and makes the node 100 enter normal node. When the node 100 enters normal node, the sleep control unit 140 starts the functions of the traffic control unit 120 and the like which are stopped.

The node 200 includes a traffic control information storage unit 210, a traffic control unit 220, a transmission probability management unit 230, and a sleep control unit 240. The node 300 includes a traffic control information storage unit 310, a traffic control unit 320, a transmission probability management unit 330, and a sleep control unit 340. The node 400 includes a traffic control information storage unit 410, a traffic control unit 420, the transmission probability management unit 430, and a sleep control unit 440. The node 500 includes a traffic control information storage unit 510, a traffic control unit 520, the transmission probability management unit 530, and a sleep control unit 540. The function of each component in the nodes 200, 300, 400, and 500 is the same as that of a component in the node 100 having the same name.

By adopting the above system structure, a packet which flows into an entry node of the network 10 is transmitted to an exit node via a proper path and is sent out to another network. For example, a packet which flows into the node 100 is transmitted to the node 400 or 500 by the traffic control unit 120. Furthermore, a packet which flows into the node 200 is transmitted to the node 400 or 500 by the traffic control unit 220. The node 100 or 200 which functions as an entry node adds, for example, route information regarding a path to the packet transmitted. In this case, the traffic control unit 420 or 520 of the node 400 or 500 which receives the packet transmits the packet in accordance with the route information added thereto. As a result, even if a packet is relayed by a plurality of relay nodes, the packet is transmitted to an exit node via a path determined by an entry node.

The traffic control unit 120 distributes packets by the use of an existing routing protocol, such as OSPF (Open Shortest Path First) or RIP (Routing Information Protocol), or an existing packet transmission technique, such as MPLS (Multi-Protocol Label Switching), until the traffic attraction of each link is set. There is no traffic right after the operation of the system is begun. Accordingly, no link has attraction (attraction of each link remains the initial value “0”). Traffic in such initial stages is distributed by the traffic control unit 120 in accordance with definitions in the existing routing protocol or packet transmission technique. When the traffic reaches a destination node, the destination node generates a control packet including traffic attraction and transmits it to another node. As a result, the node 100 also sets attraction associated with each link. After that, the traffic control unit 120 distributes packets or a packet flow on the basis of traffic attraction.

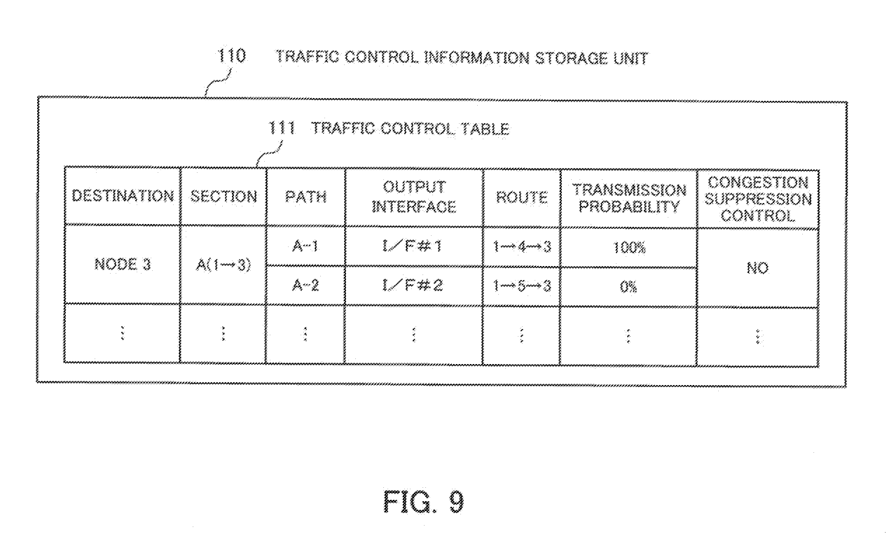

FIG. 9 illustrates an example of the data structure of the traffic control information storage unit. Information used by the traffic control unit 120 for determining a packet transmission route is set in the traffic control information storage unit 110. In the example of FIG. 9, a traffic control table 111 is stored in the traffic control information storage unit 110.

The traffic control table 111 includes Destination, Section, Path, Output Interface, Route, Transmission Probability, and Congestion Suppression Control columns.

Node ID of an exit node which is a packet destination is set in the Destination column. In the example of FIG. 9, the node ID “3” of the node 300 is set in the Destination column.

A combination of an entry node and an exit node is defined as a section and section ID of the section is set in the Section column. In the example of FIG. 9, the section ID “A” of a section that is a combination of the node 100 as an entry node node ID of which is “1” and the node 300 as an exit node node ID of which is “3” is set in the Section column.

Identification data for a path which can be used for transmitting a packet to a destination node is set in the Path column. For example, path ID is a combination of section ID and the serial number of a path in a corresponding section. In the example of FIG. 9, “A-1” and “A-2” are set as path ID.

ID (interface ID) of a communication interface connected to an adjacent node on a path corresponding to path ID is set in the Output Interface column.

A node on a route of a path corresponding to path ID is set in the Route column. In the example of FIG. 9, a path the path ID of which is “A-1” is represented as a route on which the node 400 the node ID of which is “4” is a relay node. In addition, a path the path ID of which is “A-2” is represented as a route on which the node 500 the node ID of which is “5” is a relay node.

A transmission probability for a path indicated by path ID is set in the Transmission Probability column. If traffic is centralized, then a transmission probability for one path is “100%”.

Information indicative of whether congestion suppression control is exercised or not is set according to destination in the Congestion Suppression Control column.

The detailed structure of the transmission probability management unit 130 will now be described.

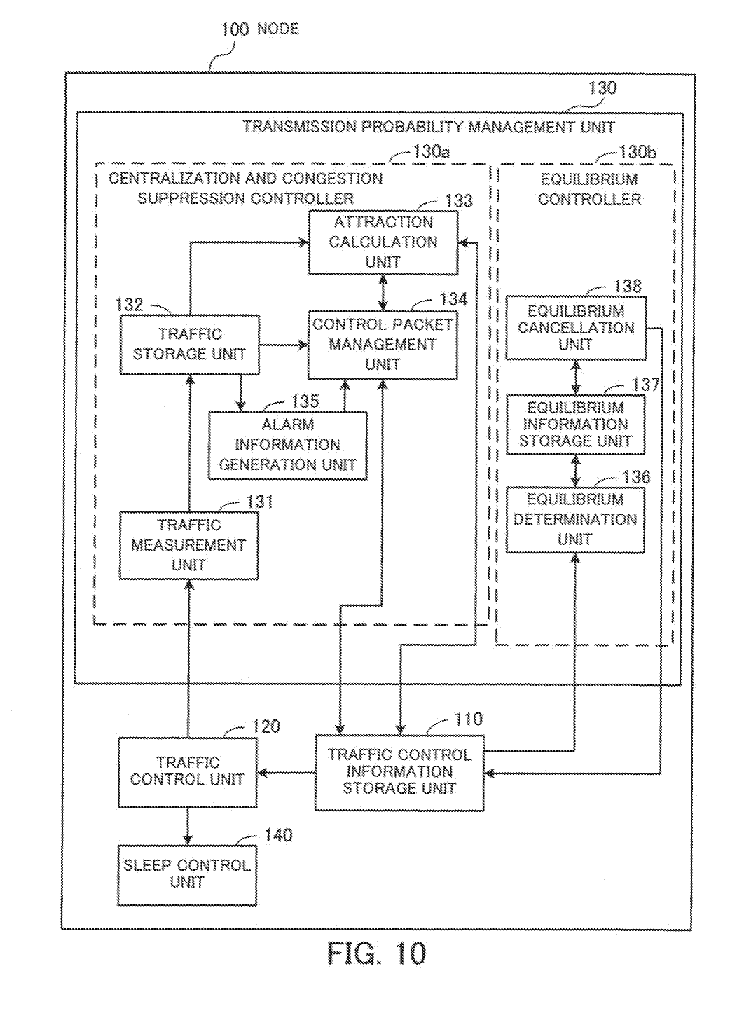

FIG. 10 illustrates an example of the detailed structure of the transmission probability management unit in the second embodiment. The functions of the transmission probability management unit 130 are broadly divided into a centralization and congestion suppression controller 130a and an equilibrium controller 130b. The centralization and congestion suppression controller 130a calculates the attraction of a path in centralization control, gives instructions, at the time of detecting a symptom of congestion, to begin congestion suppression control, and the like. The equilibrium controller 130b exercises control for changing an equilibrium state which has arisen between traffic volumes on a plurality of paths in one section.

The centralization and congestion suppression controller 130a includes a traffic measurement unit 131, a traffic storage unit 132, an attraction calculation unit 133, a control packet management unit 134, and an alarm information generation unit 135.

The traffic measurement unit 131 measures the volume of traffic handled by each link (transmission route between the node 100 and an adjacent node). To be concrete, the traffic measurement unit 131 monitors traffic control by the traffic control unit 120 and measures the volume of traffic which flows into or out of each of the communication interfaces 107a, 107b, and 107c. The traffic measurement unit 131 stores the traffic volume measured in the traffic storage unit 132.

The traffic storage unit 132 stores the volume of traffic which flows into each of the communication interfaces 107a, 107b, and 107c. For example, a part of a storage area in the RAM 102 is used as the traffic storage unit 132.

The attraction calculation unit 133 calculates attraction as the occasion arises. When the node 100 functions as an exit node, the attraction calculation unit 133 calculates the attraction of each link by the use of, for example, the usage percentage of a link from which traffic flows in ((traffic volume)/(link bandwidth)). When the node 100 functions as a relay node, the attraction calculation unit 133 calculates the attraction of each attraction propagation link by the use of, for example, not only the usage percentage of a link from which traffic flows in but also attraction of which an adjacent node on the exit node side informs the node 100. An attraction propagation link means a link other than a link via which the node 100 receives attraction. For example, the attraction calculation unit 133 calculates the attraction of each attraction propagation link by the use of the formula:

attraction=0.5×{sum of usage percentages of inflow links)+(attraction of which node 100 is informed)}×(usage percentage of attraction propagation link in inflow direction) (1)

Multiplying by 0.5 means that the average of attraction of which the node 100 is informed and the sum of the usage percentages of links which flow into the node 100 is taken. An exit node is not informed of attraction. Therefore, an exit node calculates attraction by the use of the formula:

attraction=(sum of usage percentages of inflow links)×(usage percentage of attraction propagation link in inflow direction) (2)

All of links along which traffic flows into an exit node are attraction propagation links for the exit node. When the node 100 functions as an exit node or a relay node, attraction calculated by the attraction calculation unit 133 is passed to the control packet management unit 134.

When the node 100 functions as an entry node, the attraction calculation unit 133 considers attraction of which an adjacent node on the exit node side informs the node 100 as the attraction of a link between the node 100 and the adjacent node. The attraction of a link calculated by the attraction calculation unit 133 increases with an increase in the usage percentage of the link.

When the node 100 functions as an entry node, the attraction calculation unit 133 considers the attraction of a link of which the node 100 is informed as the attraction of a path which includes the link and along which traffic flows out. On the basis of the attraction of the path, the attraction calculation unit 133 then calculates a transmission probability for the path. For example, the attraction calculation unit 133 proportionally distributes the value of 100% to paths according to their attraction. To be concrete, the attraction of each of all paths in the same section is divided by the total of the attraction of all the paths in the section and a division result is considered as a transmission probability for each path. In the second embodiment a division result is multiplied by 100 and a transmission probability is expressed in percent.

The control packet management unit 134 manages the generation and transmission of a control packet. To be concrete, when the node 100 functions as an exit node, the control packet management unit 134 receives attraction according to link generated periodically from the attraction calculation unit 133 and generates control packets according to link. A control packet generated includes the attraction of each link. The control packet management unit 134 then transmits the control packets according to link via communication interfaces connected to corresponding links.

In addition, when the node 100 functions as a relay node, the control packet management unit 134 passes traffic attraction included in a control packet transmitted thereto from another node to the attraction calculation unit 133. After that, the control packet management unit 134 receives attraction after update according to attraction propagation link from the attraction calculation unit 133. Furthermore, the control packet management unit 134 copies the control packet received in order to generate control packets according to attraction propagation link. Next, the control packet management unit 134 updates the attraction included in each of the control packets according to attraction propagation link by the use of the attraction after update received from the attraction calculation unit 133. The control packet management unit 134 then transmits the control packets corresponding to attraction propagation links via communication interfaces connected to the attraction propagation links.

In addition, the control packet management unit 134 sets whether congestion suppression control is exercised or not in the traffic control table 111 according to the contents of a control packet. To be concrete, if alarm information indicative of the possibility of the occurrence of congestion is included in a control packet, then the control packet management unit 134 determines that there is a possibility that congestion will occur on a route including a link along which the control packet is transmitted. If the control packet management unit 134 receives alarm information from the alarm information generation unit 135, the control packet management unit 134 also determines that there is a possibility that congestion will occur. The control packet management unit 134 then set information which is indicative that congestion suppression control is exercised for a section in the traffic control table 111 having a path including a link on which congestion may occur. Furthermore, if the possibility of the occurrence of congestion is not detected on any path in a section in which the node 100 functions as an entry node, then the control packet management unit 134 sets information which is indicative that congestion suppression control is not exercised for the section in the traffic control table 111.

When the control packet management unit 134 receives the alarm information from the alarm information generation unit 135, the control packet management unit 134 broadcasts a control packet including the alarm information to links other than a link on which congestion may occur. At this time the control packet management unit 134 can transmit a control packet by which notice of attraction is given and which includes the alarm information. Alternatively, the control packet management unit 134 can generate and transmit a control packet by which only notice of the alarm information is given without waiting until the receiving of a control packet by which notice of attraction is given.

The alarm information generation unit 135 monitors the traffic storage unit 132 and determines whether or not the traffic usage percentage of each link is greater than a determined threshold (traffic usage limit value). If there is a link on which a traffic usage percentage is greater than a determined threshold, then the alarm information generation unit 135 generates alarm information and passes it to the control packet management unit 134. While the usage percentage of the link is greater than the threshold, the alarm information generation unit 135 periodically generates alarm information for the link.

The equilibrium controller 130b includes an equilibrium determination unit 136, an equilibrium information storage unit 137, and an equilibrium cancellation unit 138.

The equilibrium determination unit 136 determines whether or not an equilibrium state has arisen in each section in which the node 100 functions as an entry node. For example, the equilibrium determination unit 136 refers to the traffic control information storage unit 110 and determines whether or not an equilibrium state has continued for a determined period of time among a plurality of paths in the same section. If an equilibrium state has continued for the determined period of time, then the equilibrium determination unit 136 determines that the section is in an equilibrium state. The equilibrium determination unit 136 sets in the equilibrium information storage unit 137 the determination result that the section is in an equilibrium state or that the section is not in an equilibrium state. In addition, the equilibrium determination unit 136 determines whether or not the equilibrium state of a section is canceled. If the equilibrium state of the section is canceled, then the equilibrium determination unit 136 sets in the equilibrium information storage unit 137 the fact that the equilibrium state of the section is canceled.

The equilibrium information storage unit 137 stores equilibrium state management information according to destination. For example, a part of a storage area of the RAM 102 or the HDD 103 is used as the equilibrium information storage unit 137. The equilibrium state management information includes a flag which is indicative whether or not a section is in an equilibrium state, time at which an equilibrium cancellation process is performed in a section in an equilibrium state, and the like.

The equilibrium cancellation unit 138 performs an equilibrium cancellation process in a section in an equilibrium state. For example, the equilibrium cancellation unit 138 determines time at which equilibrium cancellation operation is performed in the section in an equilibrium state. For example, the equilibrium cancellation unit 138 multiplies a random numeric value by a determined period of time to obtain wait time. When the wait time elapses from the present time, equilibrium cancellation operation is performed.

If the section in an equilibrium state is still in an equilibrium state at the time when equilibrium cancellation operation is performed, then the equilibrium cancellation unit 138 sets transmission probabilities for paths in the section in the traffic control information storage unit 110 so that there will be a great difference between the transmission probabilities. In the second embodiment it is assumed that a predetermined value is used as a transmission probability at equilibrium cancellation time. For example, if there are two paths in the section in an equilibrium state, then setting is performed so as to distribute traffic at a ratio of 8 to 2. In this case, a transmission probability for one path is set to “80%” and a transmission probability for the other path is set to “20%”. An arbitrary value is set in advance as a transmission probability at equilibrium cancellation time by operation input provided by an operator.

Information held in the transmission probability management unit 130 will now be described in detail.

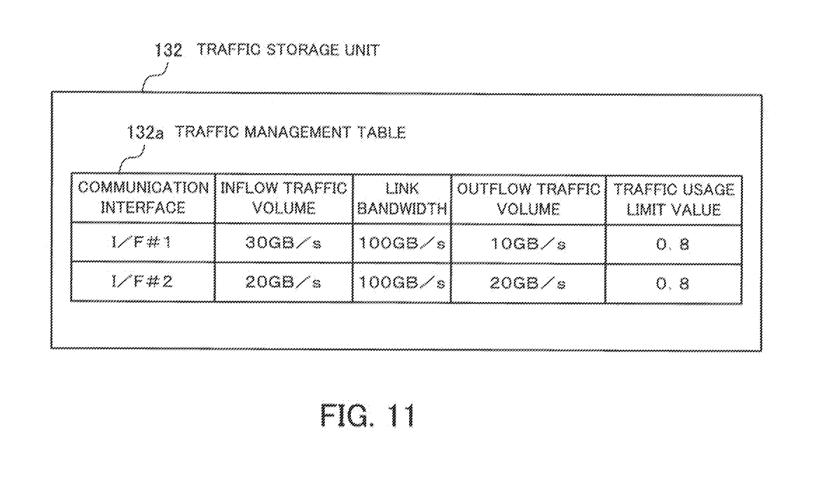

FIG. 11 illustrates an example of the data structure of the traffic storage unit. The traffic storage unit 132 stores a traffic management table 132a. The traffic management table 132a includes Communication Interface, Inflow Traffic Volume, Link Bandwidth, Outflow Traffic Volume, and Traffic Usage Limit Value columns.

An identifier of a communication interface connected to another node in the network 10 is set in the Communication Interface column. As illustrated in FIG. 3, the two communication interfaces 107a and 107b of the node 100 are connected to the nodes 400 and 500, respectively, in the network 10. Therefore, identifiers of the communication interfaces 107a and 107b are set in the Communication Interface column.

The volume of traffic which flows into a corresponding communication interface is set in the Inflow Traffic Volume column. The volume of traffic is indicated by inflow data capacity per second.

Maximum link transmission capacity at the time of performing communication by the use of a corresponding communication interface is set in the Link Bandwidth column. A link bandwidth is indicated by data capacity which can flow in per second.

The volume of traffic which flows out via a corresponding communication interface is set in the Outflow Traffic Volume column. The volume of traffic is indicated by outflow data capacity per second.

A threshold of the usage percentage of traffic which can flow out via a corresponding communication interface without causing congestion is set in advance in the Traffic Usage Limit Value column.

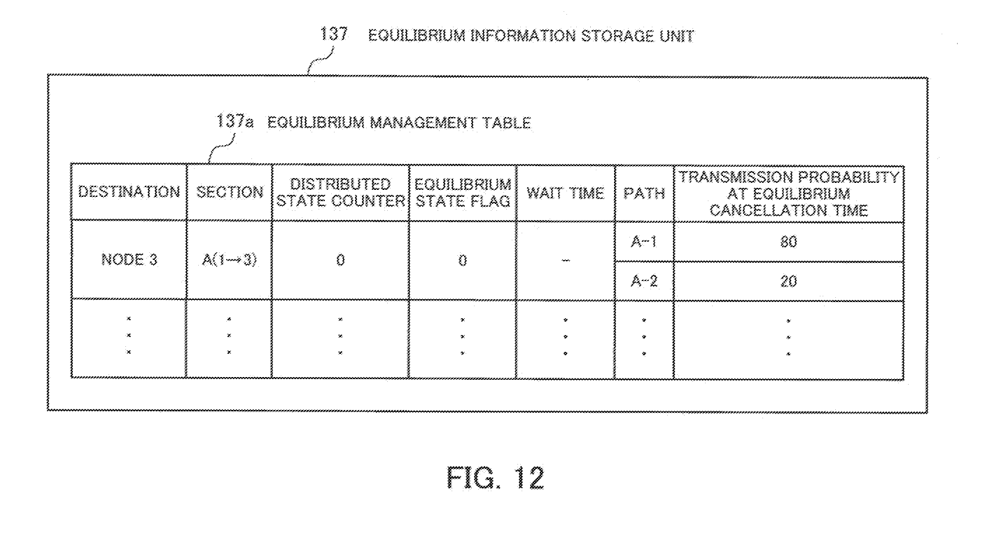

FIG. 12 illustrates an example of the data structure of the equilibrium information storage unit. The equilibrium information storage unit 137 stores an equilibrium management table 137a. The equilibrium management table 137a includes Destination, Section, Distributed State Counter, Equilibrium State Flag, Wait Time, Path, and Transmission Probability at Equilibrium Cancellation Time columns.

Node ID of a destination node is set in the Destination column.

Section ID of a section from the node 100 which functions as an entry node to a destination node is set in the Section column.

A counter (distributed state counter) for gauging a period for which traffic in a corresponding section is distributed among a plurality of paths is set in the Distributed State Counter column. For example, each time a distributed state continues for one minute, the value of the distributed state counter is incremented by one.

A flag (equilibrium state flag) indicative of whether or not a corresponding section is in an equilibrium state is set in the Equilibrium State Flag column. For example, if the corresponding section is not in an equilibrium state, then the equilibrium state flag is set to “0”. If the corresponding section is in an equilibrium state, then the equilibrium state flag is set to “1”.

Wait time from the time when a corresponding section goes into an equilibrium state to the time when equilibrium cancellation operation is performed is set in the Wait Time column.

Path ID of a path used for transmitting traffic in a corresponding section is set in the Path column.

A transmission probability for each path in the case of performing an equilibrium cancellation process is set in the Transmission Probability at Equilibrium Cancellation Time column. In the second embodiment a transmission probability at equilibrium cancellation time is set in advance by operation input provided by the operator.

As has been described, a transmission probability is set according to attraction or whether or not a section is in an equilibrium state, and a symptom of congestion is detected.

Processes performed by the equilibrium controller 130b will now be described in further detail.

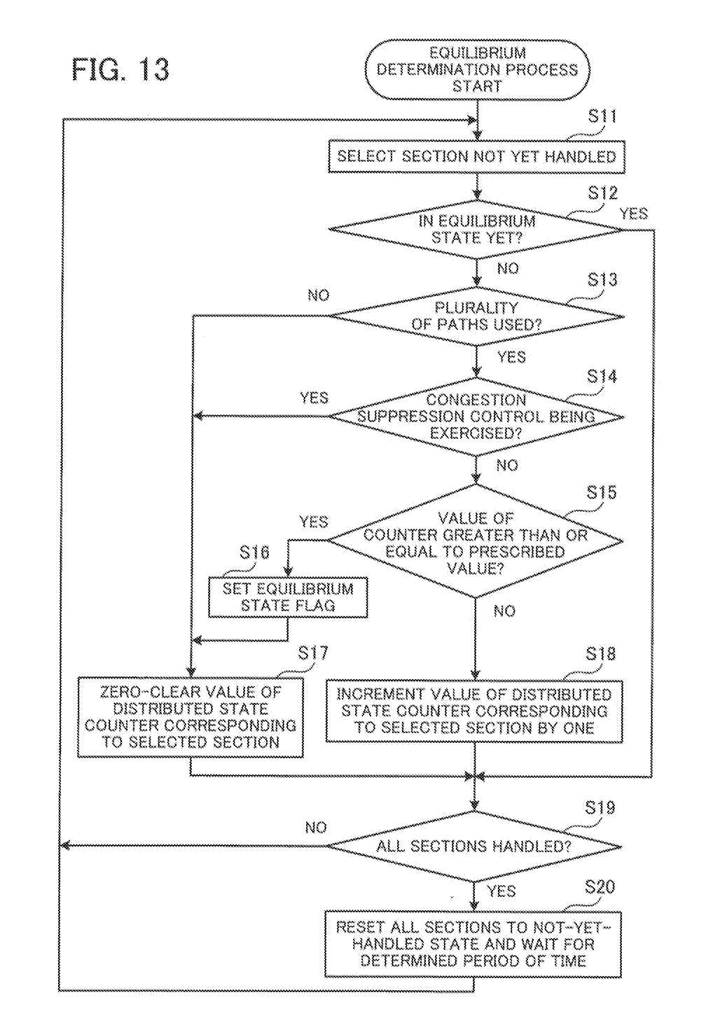

FIG. 13 is a flow chart of a procedure for an equilibrium determination process. The equilibrium determination process is performed repeatedly by the equilibrium determination unit 136. The process illustrated in FIG. 13 will now be described in order of step number.

(Step S11) The equilibrium determination unit 136 refers to the traffic control table 111 and selects one section in which the node 100 functions as an entry node and which is not yet handled.

(Step S12) The equilibrium determination unit 136 refers to the equilibrium management table 137a and determines whether or not the selected section is already in an equilibrium state. To be concrete, if an equilibrium state flag of the selected section is set to “1,” then the equilibrium determination unit 136 determines that the selected section is in an equilibrium state. If the selected section is already in an equilibrium state, then the equilibrium determination unit 136 proceeds to step S19. If the selected section is not in an equilibrium state, then the equilibrium determination unit 136 proceeds to step S13.

(Step S13) The equilibrium determination unit 136 refers to the traffic control table 111 and determines whether or not a plurality of paths are used in the selected section. To be concrete, if there are two or more paths for which transmission probabilities are not “0%,” then the equilibrium determination unit 136 determines that a plurality of paths are used. If a plurality of paths are used, then the equilibrium determination unit 136 proceeds to step S14. If only one path is used, then the equilibrium determination unit 136 determines that traffic is centralized, and proceeds to step S17.

(Step S14) The equilibrium determination unit 136 refers to the traffic control table 111 and determines whether or not congestion suppression control is being exercised in the selected section. To be concrete, if “YES” is set in the Congestion Suppression Control column corresponding to the selected section, then the equilibrium determination unit 136 determines that congestion suppression control is being exercised in the selected section. If “NO” is set in the Congestion Suppression Control column corresponding to the selected section, then the equilibrium determination unit 136 determines that congestion suppression control is not being exercised in the selected section. If congestion suppression control is being exercised in the selected section, then the equilibrium determination unit 136 determines that a distributed state should be tolerated, and proceeds to step S17. If congestion suppression control is not being exercised in the selected section, then the equilibrium determination unit 136 proceeds to step S15.

(Step S15) The equilibrium determination unit 136 refers to the equilibrium management table 137a and determines whether or not the value of a distributed state counter corresponding to the selected section is greater than or equal to a prescribed value set in advance. If the value of the distributed state counter is greater than or equal to the prescribed value, then the equilibrium determination unit 136 determines that the selected section is in an equilibrium state, and proceeds to step S16. If the value of the distributed state counter is smaller than the prescribed value, then the equilibrium determination unit 136 proceeds to step S18.

(Step S16) The equilibrium determination unit 136 sets an equilibrium state flag in the equilibrium management table 137a corresponding to the selected section to “1” (equilibrium state).

(Step S17) The equilibrium determination unit 136 zero-clears the value of the distributed state counter in the equilibrium management table 137a corresponding to the selected section. Zero clear means setting a value to “0”. After that, the equilibrium determination unit 136 proceeds to step S19.

(Step S18) The equilibrium determination unit 136 increments the value of the distributed state counter in the equilibrium management table 137a corresponding to the selected section by one.

(Step S19) The equilibrium determination unit 136 determines whether or not all sections in which the node 100 functions as an entry node are handled. If all the sections in which the node 100 functions as an entry node are handled, then the equilibrium determination unit 136 proceeds to step S20. If there is a section in which the node 100 functions as an entry node and which is not yet handled, then the equilibrium determination unit 136 proceeds to step S11.

(Step S20) The equilibrium determination unit 136 resets all sections to a not-yet-handled state and waits for a determined period of time (one minute, for example). The equilibrium determination unit 136 proceeds to step S11 after the elapse of wait time.

As has been described, if there is a section in which a traffic distributed state continues for a prescribed period of time, then the determination that the section is in an equilibrium state is made. That is to say, if there is a section in which congestion suppression control is not being exercised and in which a plurality of paths are used for a prescribed period of time (traffic is not centralized on one path), then the determination that the section is in an equilibrium state is made.

A process for determining, in the case of the determination that a section is in an equilibrium state being made, whether or not the equilibrium state is canceled will now be described in detail.

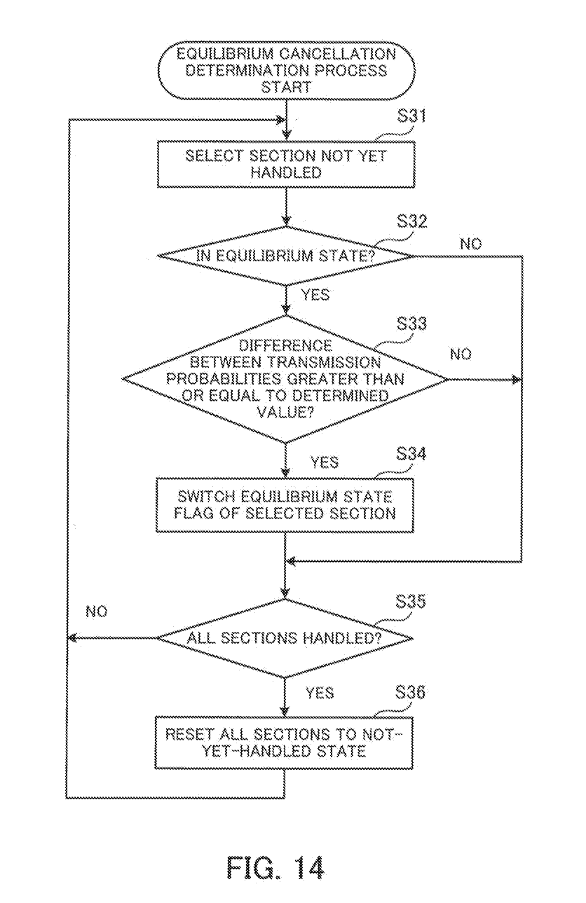

FIG. 14 is a flow chart of a procedure for an equilibrium cancellation determination process. The equilibrium cancellation determination process is performed repeatedly by the equilibrium determination unit 136. The process illustrated in FIG. 14 will now be described in order of step number.

(Step S31) The equilibrium determination unit 136 refers to the equilibrium management table 137a and selects one section in which the node 100 functions as an entry node and which is not yet handled.

(Step S32) The equilibrium determination unit 136 refers to an equilibrium state flag of the selected section and determines whether or not the selected section is in an equilibrium state. If the selected section is in an equilibrium state, then the equilibrium determination unit 136 proceeds to step S33. If the selected section is not in an equilibrium state, then the equilibrium determination unit 136 proceeds to step S35.

(Step S33) The equilibrium determination unit 136 refers to the traffic control table 111 and determines whether or not the difference between transmission probabilities for paths in the selected section is greater than or equal to a determined value. For example, if there is a path a transmission probability for which is higher than or equal to 80%, then the equilibrium determination unit 136 determines that there is a difference between the transmission probabilities for the paths in the selected section. If the difference between the transmission probabilities for the paths in the selected section is greater than or equal to the determined value, then the equilibrium determination unit 136 proceeds to step S34. If the difference between the transmission probabilities for the paths in the selected section is smaller than the determined value, then the equilibrium determination unit 136 proceeds to step S35.

(Step S34) The equilibrium determination unit 136 switches the equilibrium state flag of the selected section in the equilibrium management table 137a (to “0”). In addition, the equilibrium determination unit 136 deletes wait time for the selected section.

(Step S35) The equilibrium determination unit 136 determines whether or not all sections in which the node 100 functions as an entry node are handled. If all the sections in which the node 100 functions as an entry node are handled, then the equilibrium determination unit 136 proceeds to step S36. If there is a section in which the node 100 functions as an entry node and which is not yet handled, then the equilibrium determination unit 136 proceeds to step S31.

(Step S36) The equilibrium determination unit 136 resets all sections to a not-yet-handled state and proceeds to step S31.

As has been described, if an equilibrium state is canceled, an equilibrium state flag is switched. That is to say, if a temporary equilibrium state of a section is canceled before the elapse of wait time, then the process of changing transmission probabilities for equilibrium cancellation is not performed.

An equilibrium cancellation process will now be described.

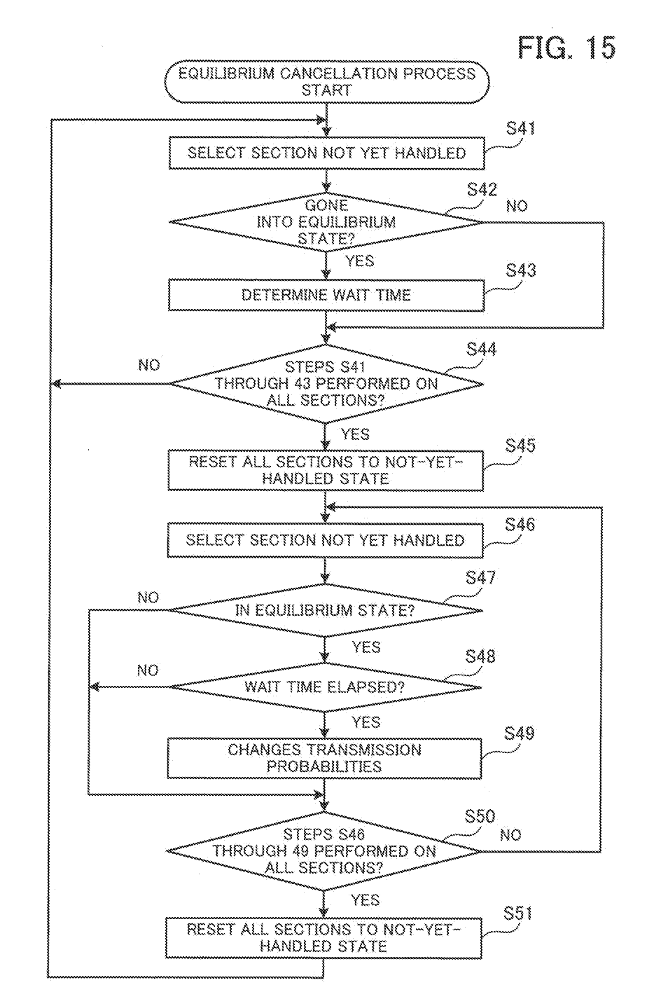

FIG. 15 is a flow chart of a procedure for an equilibrium cancellation process. The equilibrium cancellation process is performed repeatedly by the equilibrium cancellation unit 138. The process illustrated in FIG. 15 will now be described in order of step number.

(Step S41) The equilibrium cancellation unit 138 refers to the equilibrium management table 137a and selects one section in which the node 100 functions as an entry node and which is not yet handled.

(Step S42) The equilibrium cancellation unit 138 refers to the equilibrium management table 137a and determines whether or not the selected section has newly gone into an equilibrium state. To be concrete, if an equilibrium state flag of the selected section is “1” and wait time is not set, then the equilibrium cancellation unit 138 determines that the selected section has newly gone into an equilibrium state. If the selected section has newly gone into an equilibrium state, then the equilibrium cancellation unit 138 proceeds to step S43. If the selected section has not gone into an equilibrium state or the selected section is in an equilibrium state for some time, then the equilibrium cancellation unit 138 proceeds to step S44.

(Step S43) The equilibrium cancellation unit 138 determines time for which it waits until performing equilibrium cancellation operation. For example, the equilibrium cancellation unit 138 randomly generates one of 0, 1, 2, 3, 4, 5, 6, 7, 8, 9, and 10 minutes and considers the generated time as the wait time. Equilibrium cancellation operation is performed after the elapse of the wait time from the present time.

(Step S44) The equilibrium cancellation unit 138 determines whether or not steps S41 through 43 are performed on all sections in which the node 100 functions as an entry node. If steps S41 through 43 are performed on all the sections in which the node 100 functions as an entry node, then the equilibrium cancellation unit 138 proceeds to step S45. If there is a section in which the node 100 functions as an entry node and on which steps S41 through 43 are not yet performed, then the equilibrium cancellation unit 138 proceeds to step S41.

(Step S45) The equilibrium cancellation unit 138 resets all sections to a not-yet-handled state and proceeds to step S46.

(Step S46) The equilibrium cancellation unit 138 refers to the equilibrium management table 137a and selects one section in which the node 100 functions as an entry node and which is not yet handled.

(Step S47) The equilibrium cancellation unit 138 refers to the equilibrium management table 137a and determines whether or not the selected section is in an equilibrium state. To be concrete, if an equilibrium state flag of the selected section is “1,” then the equilibrium cancellation unit 138 determines that the selected section is in an equilibrium state. If the selected section is in an equilibrium state, then the equilibrium cancellation unit 138 proceeds to step S48. If the selected section is not in an equilibrium state, then the equilibrium cancellation unit 138 proceeds to step S50.

(Step S48) After the equilibrium cancellation unit 138 refers to the equilibrium management table 137a and determines that the selected section is in an equilibrium state, the equilibrium cancellation unit 138 determines whether or not wait time for the selected section has elapsed. If the wait time for the selected section has elapsed, then the equilibrium cancellation unit 138 proceeds to step S49. If the wait time for the selected section has not elapsed, then the equilibrium cancellation unit 138 proceeds to step S50.

(Step S49) The equilibrium cancellation unit 138 changes transmission probabilities for paths in the selected section to transmission probabilities at equilibrium cancellation time. To be concrete, the equilibrium cancellation unit 138 refers to the equilibrium management table 137a and acquires the transmission probabilities at equilibrium cancellation time for the paths in the selected section. The equilibrium cancellation unit 138 then sets the acquired transmission probabilities at equilibrium cancellation time as transmission probabilities for the paths in the selected section in the traffic control table 111.

(Step S50) The equilibrium cancellation unit 138 determines whether or not steps S46 through 49 are performed on the all sections in which the node 100 functions as an entry node. If steps S46 through 49 are performed on all the sections in which the node 100 functions as an entry node, then the equilibrium cancellation unit 138 proceeds to step S51. If there is a section in which the node 100 functions as an entry node and on which steps S46 through 49 are not yet performed, then the equilibrium cancellation unit 138 proceeds to step S46.

(Step S51) The equilibrium cancellation unit 138 resets all the sections to a not-yet-handled state and proceeds to step S41.

As has been described, timing at which equilibrium cancellation operation is performed after the elapse of random time on a section which has gone into an equilibrium state is determined. A transmission probability change process by the equilibrium cancellation operation is performed at this timing.

If the node 200, 300, 400, or 500 functions as an entry node, then it also performs the processes described in FIGS. 13 through 15. As a result, even if a plurality of sections with different entry nodes and the same destination have gone into an equilibrium state, the entry nodes perform equilibrium cancellation at different times. In addition, each entry node continues to perform transmission probability update process based on attraction. Accordingly, if one entry node sets a difference between transmission probabilities, the influence gradually spreads to the other entry node. As a result, traffic is gradually centralized.

How an equilibrium state is canceled will now be described by giving a concrete example.

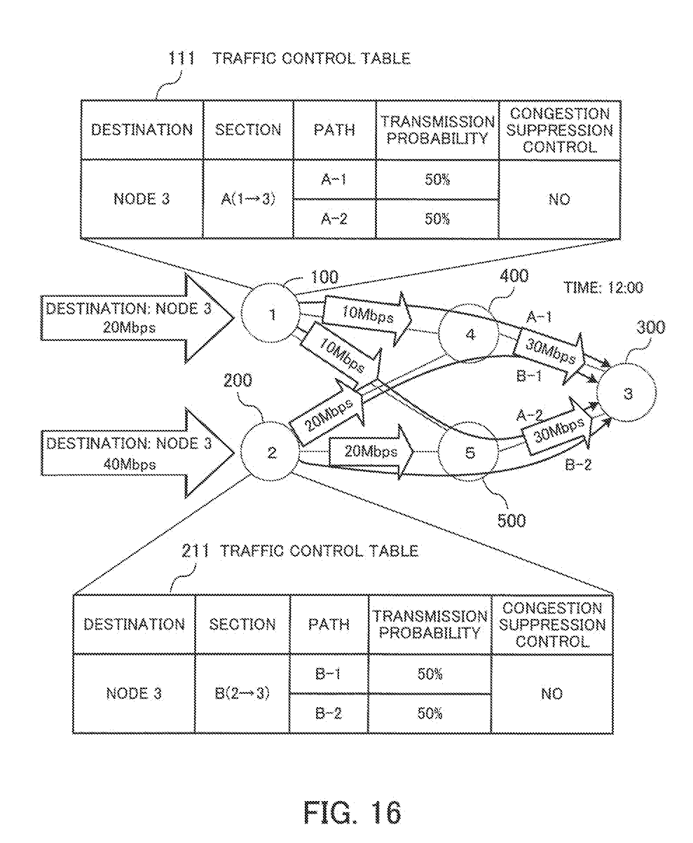

FIG. 16 illustrates an example of a state in which traffic is distributed. In the example of FIG. 16, the two paths “A-1” and “A-2” are set in a section the destination of which is the node 300 in the traffic control table 111 of the node 100. The path “A-1” is a route through the node 400. The path “A-2” is a route through the node 500. A transmission probability for each path is “50%”.

The two paths “B-1” and “B-2” are set in a section the destination of which is the node 300 in a traffic control table 211 of the node 200. The path “B-1” is a route through the node 400. The path “B-2” is a route through the node 500. A transmission probability for each path is “50%”.

In the traffic control tables 111 and 211 indicated in FIG. 16, the Output Interface and Route columns are omitted. Furthermore, it is assumed that the capacity of each link between nodes is 100 Mbps.

In the example of FIG. 16, at “12:00” traffic the volume of which is 20 Mbps and the destination of which is the node 300 flows into the node 100 and traffic the volume of which is 40 Mbps and the destination of which is the node 300 flows into the node 200. Transmission probabilities for the paths “A-1” and “A-2” in the node 100 are the same. Therefore, the node 100 distributes traffic so that a traffic volume on each path will be 10 Mbps. Furthermore, transmission probabilities for the paths “B-1” and “B-2” in the node 200 are the same. Therefore, the node 200 distributes traffic so that a traffic volume on each path will be 20 Mbps.

If a transmission probability for each path is the same, the volume of traffic which flows into the node 300 along each of the two links is also the same (30 Mbps). If the capacity of each of the two links is the same, the usage percentage of each link is also the same. It is assumed that attraction is calculated by formula (2). The attraction of each link calculated by the node 300 is the same. As a result, the node 300 informs the nodes 400 and 500 which function as relay nodes of the same attraction value.

The node 400 calculates the attraction of each link from the attraction of which the node 300 informs the node 400 and the usage percentages of the link between the nodes 400 and 100 and the link between the nodes 400 and 200. Similarly, the node 500 calculates the attraction of each link from the attraction of which the node 300 informs the node 500 and the usage percentages of the link between the nodes 500 and 100 and the link between the nodes 500 and 200. It is assumed that attraction is calculated by formula (1). The attraction of the link from the node 100 to the node 400 calculated by the node 400 is the same as the attraction of the link from the node 100 to the node 500 calculated by the node 500. Accordingly, the node 100 receives the same attraction value from the nodes 400 and 500. As a result, the transmission probability for each path is kept at “50%”. The transmission probability for each path in the node 200 is also kept at “50%”.

Therefore, each of the nodes 100 and 200 gauges time for which a distributed state continues. If a distributed state continues for prescribed time, then each of the nodes 100 and 200 determines that the section is in an equilibrium state, and updates the equilibrium management table.

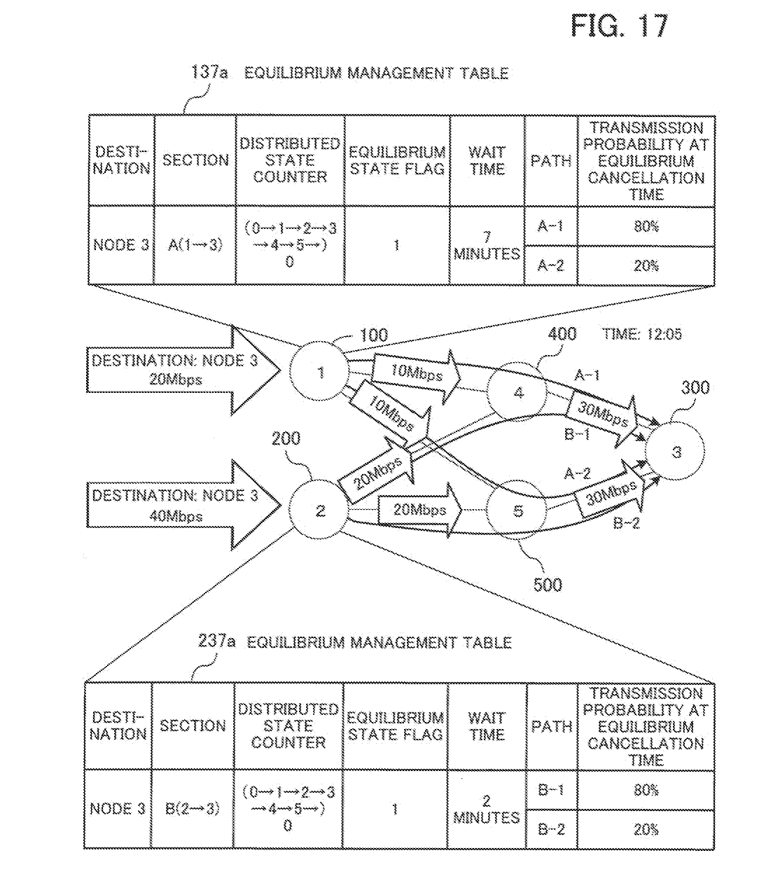

FIG. 17 illustrates examples of an equilibrium management table at the time of the determination that the sections are in an equilibrium state being made. FIG. 17 illustrates the case where an equilibrium determination process is repeated at sections of 1 minute with the prescribed time set to 5 minutes as an example.

When an equilibrium determination process is repeated at sections of 1 minute, the value of a distributed state counter is incremented in each of the equilibrium management table 137a of the node 100 and an equilibrium management table 237a of the node 200 each time one minute elapses after traffic goes into a distributed state. Five minutes later, that is to say, at 12:05 each of the nodes 100 and 200 determines that the section is in an equilibrium state, and sets a equilibrium state flag to “1”. At this time each distributed state counter is reset to “0”. If traffic is not centralized in spite of the fact that congestion suppression control is not exercised for 5 minutes, then each of the nodes 100 and 200 determines that the section is in an equilibrium state. As a result, the node 100 detects the equilibrium state of the section “A” and the node 200 detects the equilibrium state of the section “B”.

Each of the nodes 100 and 200 which detects the equilibrium state determines wait time. That is to say, each of the nodes 100 and 200 generates random time which is one of 0, 1, 2, 3, 4, 5, 6, 7, 8, 9, and 10 minutes, and considers the generated time as wait time. In the examples of FIG. 17, wait time for the node 100 is “7 minutes” and wait time for the node 200 is “2 minutes”. The determined wait time is set in the equilibrium management table 137a of the node 100 and the equilibrium management table 237a of the node 200. Transmission probabilities at equilibrium cancellation time are set in advance in each of the equilibrium management table 137a of the node 100 and the equilibrium management table 237a of the node 200 by the operator so that they will be in the ratio of 8 to 2.

As a result, two minutes later, that is to say, at 12:07 the node 200 changes the transmission probability for the path “B-1” to 80% and changes the transmission probability for the path “B-2” to 20%.

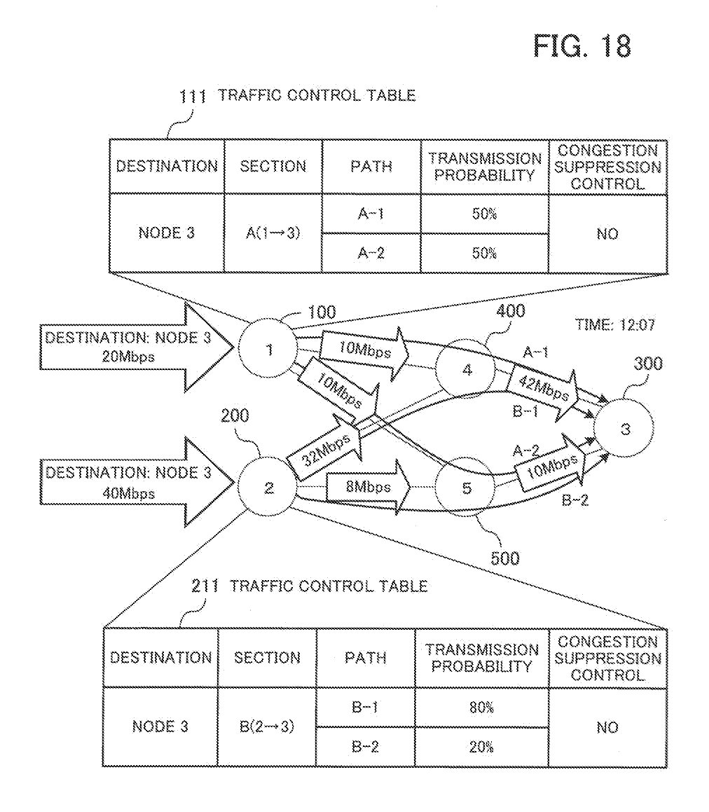

FIG. 18 illustrates an example of a change in transmission probability made by one node. The node 200 changes the transmission probabilities, so traffic which flows into the node 200 is distributed at a ratio of 8 to 2. As a result, traffic the volume of which is 32 Mbps is transmitted along the path “B-1” and traffic the volume of which is 8 Mbps is transmitted along the path “B-2”. A change by the node 100 is made seven minutes later, so at this time the transmission probabilities for the paths “A-1” and “A-2” remain at 50%.

When the sections “A” and “B” are in an equilibrium state, the volume of traffic which flows along the link from the node 400 to the node 300 is 30 Mbps. However, the node 200 changes the transmission probabilities in the section “B,” so the volume of traffic which flows along the link from the node 400 to the node 300 increases to 42 Mbps. On the other hand, when the sections “A” and “B” are in an equilibrium state, the volume of traffic which flows along the link from the node 500 to the node 300 is 30 Mbps. However, the node 200 changes the transmission probabilities in the section “B,” so the volume of traffic which flows along the link from the node 500 to the node 300 decreases to 18 Mbps. That is to say, the equilibrium cancellation process causes a difference between a traffic volume on the link from the node 400 to the node 300 and a traffic volume on the link from the node 500 to the node 300. A difference in traffic volume leads to a difference in the attraction of a path.

In the network illustrated in FIG. 18, the attraction of a path is determined through the following procedure. When the attraction of a path is calculated, the attraction of each link is calculated in order so as to follow a route of the path reversely. For example, the path “A-1” is a route for transmitting a packet in the order of the nodes 100, 400, and 300.

With this route the node 300 which functions as an exit node of the path calculates attraction first. The node 300 then informs the node 400 of the calculated attraction. Next, the node 400 updates the attraction of which the node 300 informs the node 400, and informs the node 100 of attraction after the update. The node 100 then designates the attraction of which the node 400 informs the node 100 as the attraction of the path “A-1”.

The node 300 which functions as an exit node calculates attraction by formula (2). The node 400 or 500 which functions as a relay node calculates attraction by formula (1). Attraction of which the node 400 or 500 informs the node 100 is expressed as

attraction=0.5×{(sum of usage percentages of links which flow into exit node)×(usage percentage of link connected to exit node of path)+(sum of usage percentages of links which flow into relay node)}×(usage percentage of link connected to entry node of path) (3)

The attraction of the paths “A-1” and “A-2” is calculated by substituting in formula (3) a usage percentage corresponding to a traffic volume on each link illustrated in FIG. 18.

attraction of path “A-1”=0.5×((0.42+0.18)×0.42+(0.1+0.32))×0.1=0.0336

attraction of path “A-2”=0.5×((0.42+0.18)×0.18+(0.1+0.08))×0.1=0.0144

Notice of attraction is given periodically by the use of a control packet. For example, it is assumed that the node 400 or 500 gives the node 100 notice of attraction after the elapse of thirty seconds from the state illustrated in FIG. 18. The node 100 changes a transmission probability for each path on the basis of the attraction of which the node 400 or 500 informs the node 100. If a transmission probability is calculated from attraction ratio, then a change in transmission probability is as follows.

transmission probability for path “A-1”=0.0336÷(0.0336+0.0144)×100=70%

transmission probability for path “A-2”=0.0144÷(0.0336+0.0144)×100=30%

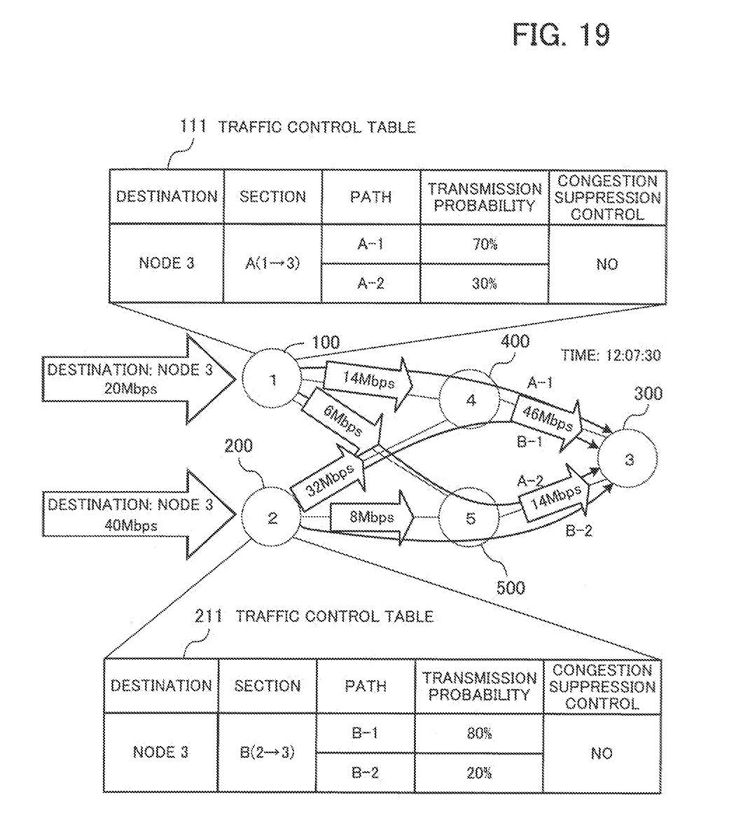

FIG. 19 illustrates a state after a change in transmission probability based on attraction. In the node 100, as indicated in FIG. 19, a transmission probability for the path “A-1” has become “70%” and a transmission probability for the path “A-2” has become “30%”. As a result, a traffic volume assigned to the path “A-1” is changed to 14 Mbps and a traffic volume assigned to the path “A-2” is changed to 6 Mbps.

In addition, the node 100 changes the transmission probabilities in the section “A,” so the volume of traffic which flows along the link from the node 400 to the node 300 increases from 42 to 46 Mbps. On the other hand, the volume of traffic which flows along the link from the node 500 to the node 300 decreases from 18 to 14 Mbps. That is to say, the degree of the centralization of traffic has become high.

After that, each of the nodes 100 and 200 changes transmission probabilities periodically on the basis of attraction. The attraction of the paths “A-1,” “A-2,” “B-1,” and “B-2” and transmission probabilities for the paths “A-1,” “A-2,” “B-1,” and “B-2” calculated from the state illustrated in FIG. 19 are as follows.

attraction of path “A-1”=0.5×((0.46+0.14)×0.46+(0.14+0.32))×0.14=0.05152→(transmission probability 88%)

attraction of path “A-2”=0.5×((0.46+0.14)×0.14+(0.06+0.08))×0.06=0.00672→(transmission probability 12%)

attraction of path “B-1”=0.5((0.46+0.14)×0.46+(0.14+0.32))×0.32=0.118→(transmission probability 93%)

attraction of path “B-2”=0.5×((0.46+0.14)×0.14+(0.06+0.08))×0.08=0.0090→(transmission probability 7%)

There are greater difference and traffic is being centralized on the paths “A-1” and “B-1”.

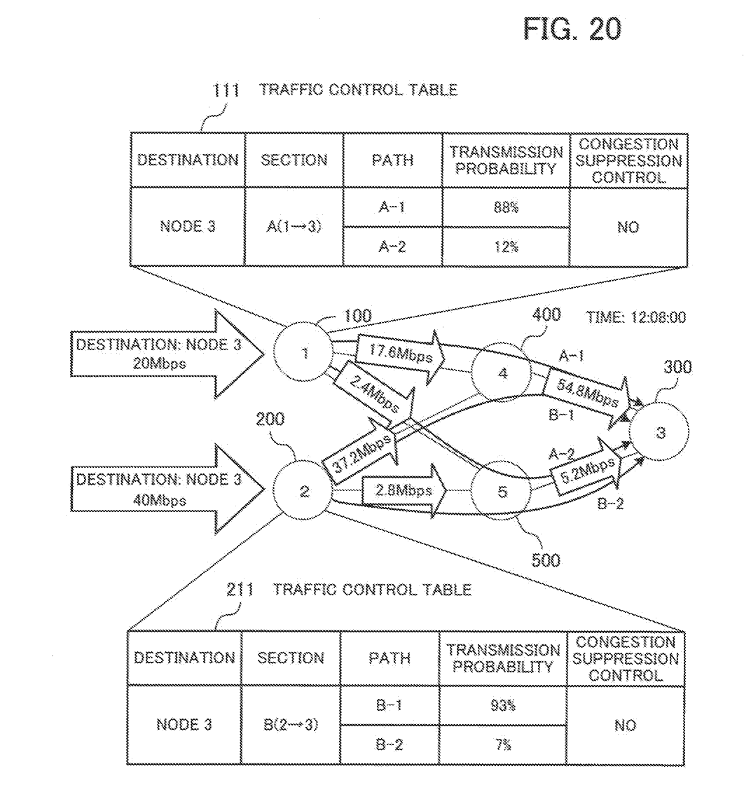

FIG. 20 illustrates a state in which centralization has progressed. In the node 100, as indicated in FIG. 20, a transmission probability for the path “A-1” has become “88%” and a transmission probability for the path “A-2” has become “12%”. As a result, a traffic volume assigned to the path “A-1” is changed to 7.6 Mbps and a traffic volume assigned to the path “A-2” is changed to 2.4 Mbps. In the node 200, a transmission probability for the path “B-1” has become “93%” and a transmission probability for the path “B-2” has become “7%”. As a result, a traffic volume assigned to the path “B-1” is changed to 37.2 Mbps and a traffic volume assigned to the path “B-2” is changed to 2.8 Mbps.

In addition, the node 100 changes the transmission probabilities in the section “A” and the node 200 changes the transmission probabilities in the section “B”. As a result, the volume of traffic which flows along the link from the node 400 to the node 300 increases from 46 to 54.8 Mbps. On the other hand, the volume of traffic which flows along the link from the node 500 to the node 300 decreases from 14 to 5.2 Mbps. That is to say, the degree of the centralization of traffic has become higher.

The attraction of the paths “A-1,” “A-2,” “B-1,” and “B-2” and transmission probabilities for the paths “A-1,” “A-2,” “B-1,” and “B-2” calculated from the state illustrated in FIG. 20 are as follows.

attraction of path “A-1”=0.5×((0.548+0.052)×0.548+(0.176+0.372))×0.176=0.047→(transmission probability 98.7%)

attraction of path “A-2”=0.5×((0.548+0.052)×0.052+(0.028+0.024))×0.024=0.001→(transmission probability 1.3%)

attraction of path “B-1”=0.5×((0.548+0.052)×0.548+(0.176+0.372))×0.372=0.163→(transmission probability 99.3%)

attraction of path “B-2”=0.5×((0.548+0.052)×0.052+(0.028+0.024))×0.028=0.0012→(transmission probability 0.7%)

Centralization has progressed further and the transmission probabilities for the paths “A-2” and “B-2” are approaching approximately 0%. Later changes will be omitted. By repeating such a change yet several times more, the transmission probabilities for the paths “A-2” and “B-2” completely become 0% and traffic is centralized on one route in each section. If a transmission probability for a path calculated becomes smaller than or equal to a determined value (1%, for example), each node may set a transmission probability for the path to “0%”.

By repeating transmission probability update based on attraction in this way, the equilibrium state is canceled without performing equilibrium cancellation operation on the section “A”. In the example of FIG. 20, all the traffic is centralized gradually on the paths “A-1” and “B-1” the attraction of which is strong, and the node 500 can enter sleep mode. That is to say, when a section is in an equilibrium state, the balance between transmission probabilities is destroyed forcedly. By doing so, traffic can be centralized on one route. By centralizing the traffic, a node which can enter sleep mode appears and power saving can be promoted.

However, if all the traffic is centralized, there are cases where congestion occurs. For example, if a traffic volume in the section “A” is 40 Mbps and a traffic volume in the section “B” is 60 Mbps, the equilibrium state of each section is canceled by congestion suppression control and a part of the traffic is distributed and transmitted to the paths “A-2” and “B-2”.

Only if a traffic volume in the section “B” is very low, little difference in traffic volume arises by canceling the equilibrium state of the section “B”, and the equilibrium state of the section “A”cannot be canceled, the node 100 performs equilibrium cancellation operation on the section scheduled to be performed seven minutes later.

If the determination that a section is in an equilibrium state is made and equilibrium cancellation operation functions, then the determination that the section is in an equilibrium state is canceled by the process indicated in FIG. 14.

### Third Embodiment

A third embodiment will now be described. According to the third embodiment, when an entry node detects an equilibrium state, the entry node informs an exit node that the equilibrium state has arisen. The entry node then determines an equilibrium cancellation method according to the contents of a response from the exit node.

At this time the exit node determines the contents of a response to be sent to each entry node on the basis of notice sent from a plurality of entry nodes. For example, the exit node adds the rank of the volume of traffic from each entry node to the contents of a response. In addition, the exit node compares routes in a plurality of sections which have gone into an equilibrium state and defines sections which are partly equal in route as related sections. Entry nodes of the related sections are related devices. Furthermore, the exit node adds the number (related section number) of sections defined as related sections with respect to a section between each entry node and the exit node to the contents of a response.

An entry node determines time (transmission probability change timing) for which the entry node waits until equilibrium cancellation operation on the basis of the rank of a traffic volume of which the exit node informs the entry node. In addition, the entry node determines a transmission probability at equilibrium cancellation time for each route on the basis of a related section number of which the exit node informs the entry node.

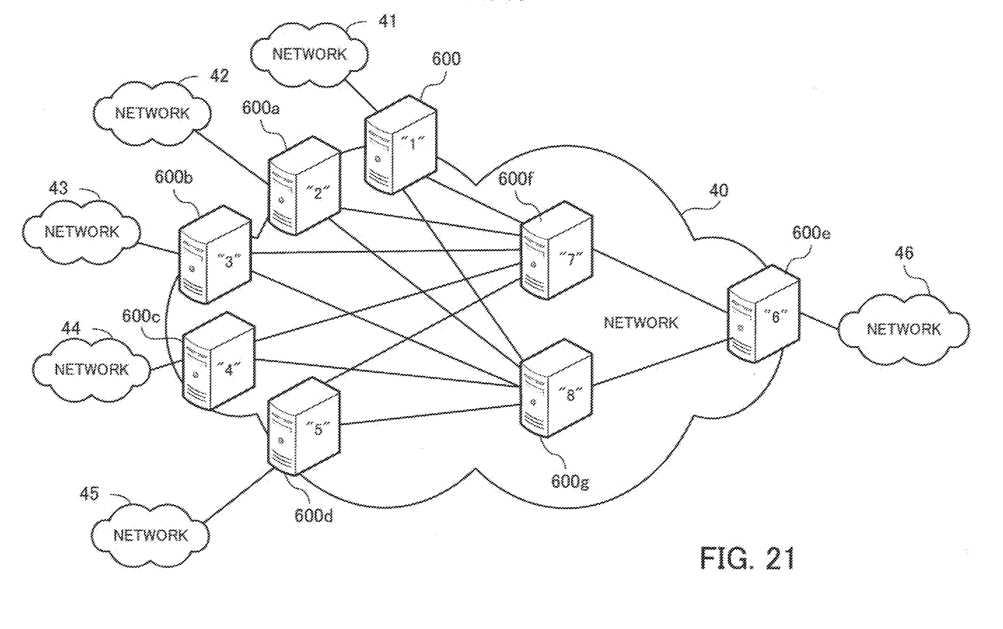

FIG. 21 illustrates an example of the structure of a system according to a third embodiment. A network 40 includes nodes 600, 600a, 600b, 600c, 600d, 600e, 600f, and 600g.

Of the nodes included in the network 40, the nodes 600, 600a, 600b, 600c, 600d, and 600e are connected to networks 41 through 46 respectively. Each of the nodes 600, 600a, 600b, 600c, 600d, and 600e functions as an edge node for not only transmitting traffic in the network 40 but also transmitting traffic inputted from or outputted to another network.

Of the nodes included in the network 40, the nodes 600f and 600g are relay nodes for transmitting traffic in the network 40. Both the nodes 600f and 600g are connected to the nodes 600, 600a, 600b, 600c, 600d, and 600e. The nodes 400 and 500 transmit traffic between the nodes 100, 200, and 300. The nodes 600f and 600g transmit traffic between the nodes 600, 600a, 600b, 600c, 600d, and 600e.

ID for identifying each node in the network 40 is given thereto. ID of the node 600 is “1”. ID of the node 600a is “2”. ID of the node 600b is “3”. ID of the node 600c is “4”. ID of the node 600d is “5”. ID of the node 600e is “6”. ID of the node 600f is “7”. ID of the node 600g is “8”.

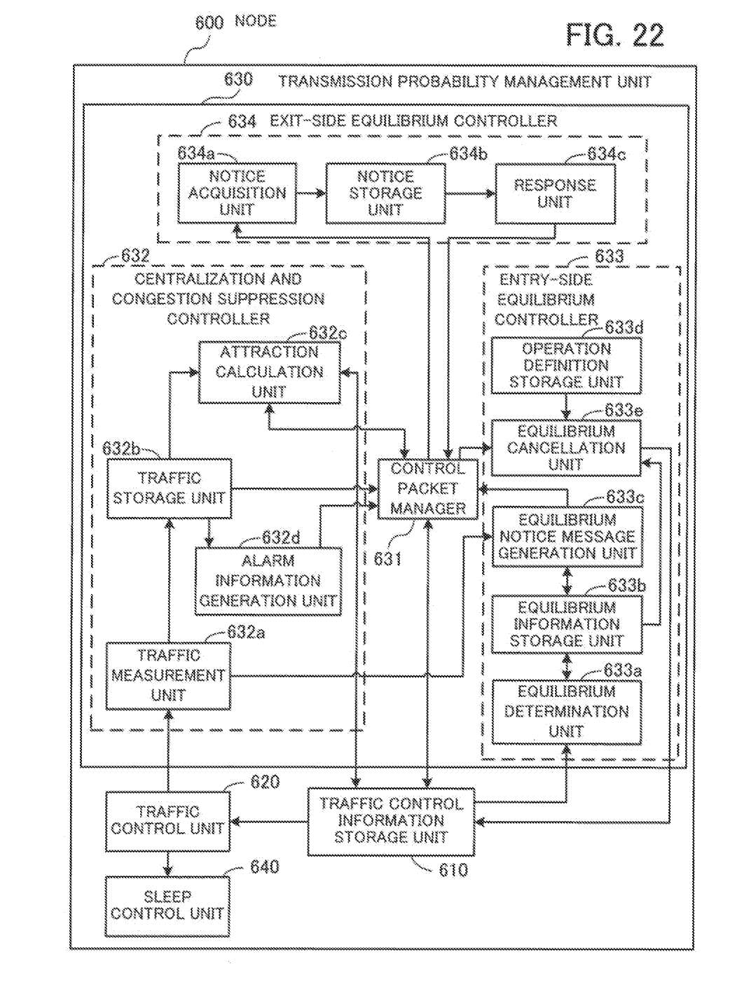

FIG. 22 is a block diagram of the functions of a node in the third embodiment. The node 600 includes a traffic control information storage unit 610, a traffic control unit 620, a transmission probability management unit 630, and a sleep control unit 640. Each of the traffic control information storage unit 610, the traffic control unit 620, and the sleep control unit 640 has the same functions as those of the component of FIGS. 8, 10, or the like in the second embodiment having the same name.

The functions of the transmission probability management unit 630 are broadly divided into a control packet manager 631, a centralization and congestion suppression controller 632, an entry-side equilibrium controller 633, and an exit-side equilibrium controller 634. The control packet manager 631 transmits information inputted from the centralization and congestion suppression controller 632, the entry-side equilibrium controller 633, or the exit-side equilibrium controller 634 to another node by the use of a control packet. In addition, the control packet manager 631 analyzes the contents of a control packet inputted from another node, and inputs the contents to the centralization and congestion suppression controller 632, the entry-side equilibrium controller 633, or the exit-side equilibrium controller 634.

The centralization and congestion suppression controller 632 calculates the attraction of a path in centralization control, gives instructions, at the time of detecting a symptom of congestion, to begin congestion suppression control, and the like.

The centralization and congestion suppression controller 632 includes a traffic measurement unit 632a, a traffic storage unit 632b, an attraction calculation unit 632c, and an alarm information generation unit 632d. Each component in centralization and congestion suppression controller 632 has the same functions as those of the component of FIG. 10 in the second embodiment having the same name.

The entry-side equilibrium controller 633 includes an equilibrium determination unit 633a, an equilibrium information storage unit 633b, an equilibrium notice message generation unit 633c, an operation definition storage unit 633d, and an equilibrium cancellation unit 633e. Each of the equilibrium determination unit 633a and the equilibrium information storage unit 633b has the same functions as those of the component of FIG. 10 in the second embodiment having the same name.

If there is a section which has gone into an equilibrium state, the equilibrium notice message generation unit 633c generates a notice message for informing an exit node of the section that the section has gone into an equilibrium state. The notice message is passed to the exit node via the control packet manager 631. To be concrete, the equilibrium notice message generation unit 633c refers to the equilibrium information storage unit 633b. If the equilibrium notice message generation unit 633c detects a section which has gone into an equilibrium state, then the equilibrium notice message generation unit 633c acquires a traffic volume (transmission volume) in the section from the traffic measurement unit 632a. The equilibrium notice message generation unit 633c may acquire a traffic volume in the section from, for example, a MIB (Management Information Base) included in the SNMP (Simple Network Management Protocol). The equilibrium notice message generation unit 633c then generates an equilibrium notice message including section ID of the section which has gone into an equilibrium state, paths in the section, links which make up each path, the transmission volume, and the like. The equilibrium notice message generation unit 633c passes the equilibrium notice message to the control packet manager 631.

The operation definition storage unit 633d stores the contents of a definition of equilibrium state cancellation operation according to the contents of a response from the exit node. For example, a part of a storage area of a RAM or a HDD is used as the operation definition storage unit 633d. Wait time to the beginning of a cancellation process corresponding to the rank of a traffic volume, a related section number, a transmission probability for each path corresponding to the rank of a traffic volume, and the like are defined as equilibrium state cancellation operation.

When the equilibrium cancellation unit 633e receives a response message to the equilibrium notice message from the control packet manager 631, the equilibrium cancellation unit 633e refers to the operation definition storage unit 633d and determines wait time to the beginning of an equilibrium cancellation process and a transmission probability at equilibrium cancellation time for each path. The equilibrium cancellation unit 633e then updates a transmission probability for each path in the section in the traffic control information storage unit 610 which has gone into an equilibrium state so that the determined transmission probability for each path will be realized after the elapse of the determined wait time.

The exit-side equilibrium controller 634 includes a notice acquisition unit 634a, a notice storage unit 634b, and a response unit 634c.

The notice acquisition unit 634a acquires the equilibrium notice message via the control packet manager 631. The notice acquisition unit 634a then stores the acquired equilibrium notice message in the notice storage unit 634b.

The notice storage unit 634b stores an equilibrium notice message transmitted from an entry node. For example, a part of the storage area of the RAM or the HDD is used as the notice storage unit 634b.

The response unit 634c analyzes an equilibrium notice message transmitted from an entry node, and transmits information used for determining an equilibrium cancellation method to each entry node as a response. For example, when the response unit 634c receives an equilibrium notice message from an entry node, the response unit 634c stores it in the notice storage unit 634b. After that, the response unit 634c waits a determined period of time for an equilibrium notice message to be transmitted thereto from another entry node. On the basis of equilibrium notice messages accumulated in the notice storage unit 634b in the determined period of time, the response unit 634c then generates a response message to each equilibrium notice message. For example, the response unit 634c generates a response message including the rank of a traffic volume in each section and a related section number. For example, the rank of a traffic volume in a section is rank determined by ranking in a group which consists of the section and other sections that are related sections on the basis of a traffic volume. The response unit 634c transmits the generated response message to an entry node via the control packet manager 631.

FIG. 22 illustrates the functions of the node 600. However, the nodes 600a, 600b, 600c, 600d, 600e, 600f, and 600g have the same functions.

It is assumed that sections in which the node 600a, 600b, 600c, or 600d functions as an entry node and in which the node 600e functions as an exit node have gone into an equilibrium state.

The contents of the operation definition storage unit 633d will now be described in detail.

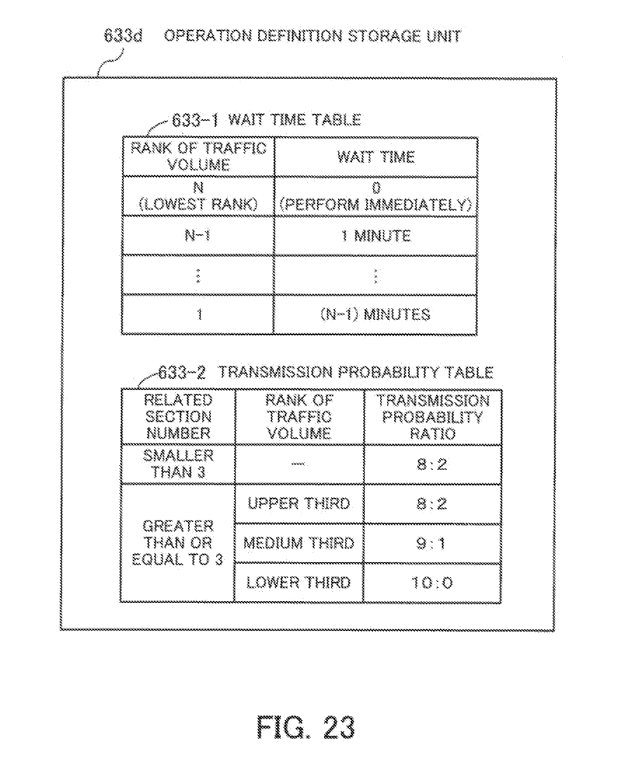

FIG. 23 illustrates an example of the data structure of the operation definition storage unit. The operation definition storage unit 633d stores a wait time table 633-1 and a transmission probability table 633-2.

Wait time corresponding to the rank of a traffic volume is defined in the wait time table 633-1. The wait time table 633-1 includes Rank of Traffic Volume and Wait Time columns. Rank determined by putting related sections in descending order of traffic volume is set in the Rank of Traffic Volume column. Wait time corresponding to the rank of a traffic volume is set in the Wait Time column. In the example of FIG. 23, as the rank of a traffic volume falls, wait time becomes shorter. For example, if the rank of a traffic volume is the lowest, performing an equilibrium cancellation process immediately is set.

A path transmission probability ratio corresponding to a related section number or the rank of a traffic volume is set in the transmission probability table 633-2. The transmission probability table 633-2 includes Related Section Number, Rank of Traffic Volume, and Transmission Probability Ratio columns.

The range of the number of related sections is set in the Related Section Number column. In the example of FIG. 23, “Smaller than 3” and “Greater than or Equal to 3” are set in the Related Section Number column.

About what position of the whole the rank of a traffic volume occupies is set in the Rank of Traffic

Volume column. In the example of FIG. 23, only if a related section number is greater than or equal to three, values are set in the Rank of Traffic Volume column. It is assumed that on the basis of the rank of a traffic volume, related sections are classified into three groups: upper third group, medium third group, and lower third group. A group to which each related section belongs is indicated in the Rank of Traffic Volume column.

A path transmission probability ratio in each section corresponding to a related section number and the rank of a traffic volume is set in the Transmission Probability Ratio column. In the example of FIG. 23, if a related section number is smaller than three, then a transmission probability for each path is set so that a path transmission probability ratio will be 8 to 2. If a related section number is greater than or equal to three and the rank of a traffic volume belongs to the upper third group, then a path transmission probability ratio is 8 to 2. If the rank of a traffic volume belongs to the medium third group, then a path transmission probability ratio is 9 to 1. If the rank of a traffic volume belongs to the lower third group, then a path transmission probability ratio is 10 to 0. That is to say, as the rank of a traffic volume falls, the difference between transmission probabilities set in an equilibrium cancellation process becomes larger.

A wait time table and a transmission probability table each including the same contents that are indicated in FIG. 23 are also stored in the nodes 600a, 600b, 600c, and 600d. That is to say, each of the nodes 600, 600a, 600b, 600c, and 600d determines wait time and a transmission probability on a common basis.

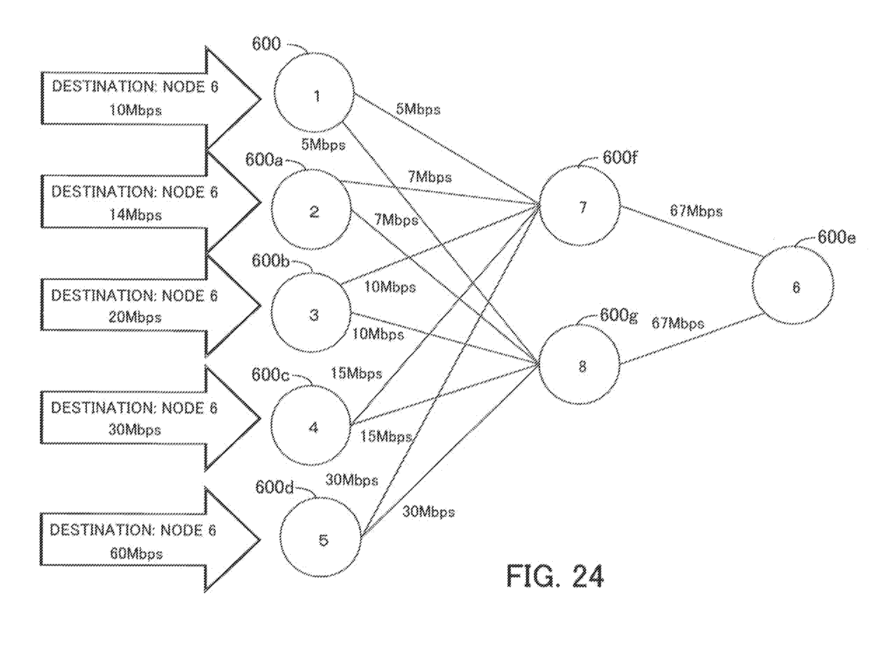

FIG. 24 illustrates an example of an equilibrium state in the third embodiment. In the example of FIG. 24, traffic the volume of which is 10 Mbps is transmitted from the node 600 to the node 600e. Traffic the volume of which is 14 Mbps is transmitted from the node 600a to the node 600e. Traffic the volume of which is 20 Mbps is transmitted from the node 600b to the node 600e. Traffic the volume of which is 30 Mbps is transmitted from the node 600c to the node 600e. Traffic the volume of which is 60 Mbps is transmitted from the node 600d to the node 600e.

Each of a section from the node 600a to the node 600e, a section from the node 600b to the node 600e, a section from the node 600c to the node 600e, and a section from the node 600d to the node 600e includes a path through the node 600f and a path through the node 600g. In the example of FIG. 24, each of the nodes 600a, 600b, 600c, and 600d distributes traffic equally to each path. As a result, a traffic volume on a link from the node 600f to the node 600e is 67 Mbps. Similarly, a traffic volume on a link from the node 600g to the node 600e is 67 Mbps. That is to say, traffic the destination of which is the node 600 has gone to an equilibrium state.

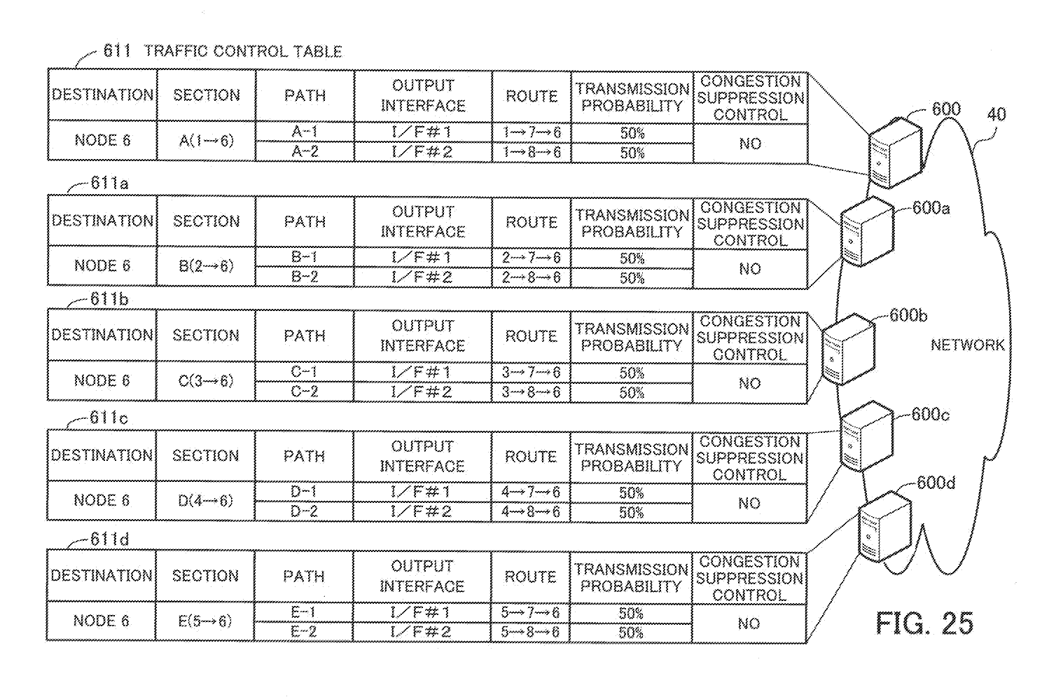

FIG. 25 illustrates the contents of a traffic control table of each entry node at the time of traffic being in an equilibrium state. As indicated in FIG. 25, a transmission probability for each path in a section is set to 50% in each of traffic control tables 611, 611a, 611b, 611c, and 611d in the nodes 600, 600a, 600b, 600c, and 600d respectively. Section ID of a section in which the node 600 functions an entry node and in which the node 600e functions as an exit node is “A”. Section ID of a section in which the node 600a functions an entry node and in which the node 600e functions as an exit node is “B”. Section ID of a section in which the node 600b functions an entry node and in which the node 600e functions as an exit node is “C”. Section ID of a section in which the node 600c functions an entry node and in which the node 600e functions as an exit node is “D”. Section ID of a section in which the node 600d functions an entry node and in which the node 600e functions as an exit node is “E”.

If the state illustrated in FIG. 25 continues, then each of the nodes 600, 600a, 600b, 600c, and 600d detects that the sections in which the node 600e functions as an exit node are in an equilibrium state. When each of the nodes 600, 600a, 600b, 600c, and 600d detects that the sections in which the node 600e functions as an exit node are in an equilibrium state, each of the nodes 600, 600a, 600b, 600c, and 600d exchanges messages with the node 600e and then performs a transmission probability change process for equilibrium cancellation.

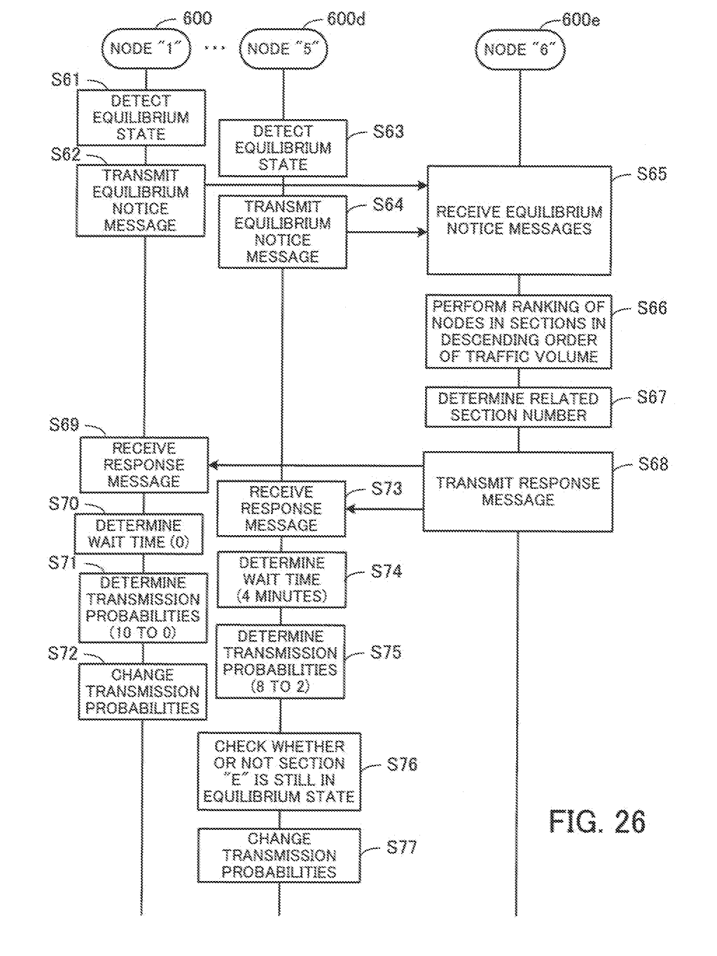

FIG. 26 is a sequence diagram of an example of a procedure for an equilibrium cancellation process in the third embodiment. Of the five entry nodes, the volume of traffic transmitted by the nodes 600 is the lowest and the volume of traffic transmitted by the nodes 600d is the highest. In the example of FIG. 26, processes performed by the nodes 600 and 600d are typically indicated. The processes illustrated in FIG. 26 will now be described in order of step number.

(Step S61) The node 600 detects an equilibrium state of the section “A”.

(Step S62) The node 600 transmits an equilibrium notice message which is indicative that the section “A” has gone into an equilibrium state to the node 600e which functions as an exit node.

(Step S63) The node 600d detects an equilibrium state of the section “E”.

(Step S64) The node 600d transmits an equilibrium notice message which is indicative that the section “E” has gone into an equilibrium state to the node 600e which functions as an exit node.

(Step S65) The node 600e receives the equilibrium notice messages transmitted from the nodes 600 and 600d. The node 600e stores the received equilibrium notice messages in the notice storage unit 634b. The time when an equilibrium notice message is transmitted from each node differs in some degree. Accordingly, after the node 600e receives the first equilibrium notice message, the node 600e waits for a determined period of time. After that, the node 600e proceeds to step S66.

(Step S66) The node 600e performs the ranking of nodes in sections which have gone into an equilibrium state in descending order of traffic volume. In the example of FIG. 24, the rank of the node 600d is “1,” the rank of the node 600c is “2,” the rank of the node 600b is “3,” the rank of the node 600a is “4,” and the rank of the node 600 is “5”.

(Step S67) The node 60e determines a related section number for each of the sections which have gone into an equilibrium state. If at least one link is common to a section and a second section, then the second section is a related section. The number of other sections related to a section is a related section number. In the example of FIG. 24, for example, the link from the node 600f to the node 600e and the link from the node 600g to the node 600e are included in all the sections. That is to say, at least one link is common to the five sections. As a result, a related section number for each section is “4”.

(Step S68) The node 600e transmits a response message to each node which transmits an equilibrium notice message to the node 600e. A related section number and the rank of a traffic volume for each node which transmits an equilibrium notice message are indicated in a response message.

(Step S69) The node 600 receives the response message.

(Step S70) The node 600 determines wait time on the basis of a related section number and the rank of a traffic volume indicated in the response message. According to the wait time table 633-1 indicated in FIG. 23, wait time for the node 600 for which the rank of a traffic volume is the lowest is “0”.

(Step S71) The node 600 determines transmission probabilities on the basis of the related section number and the rank of a traffic volume indicated in the response message. The related section number is “4” (greater than three) and the rank of a traffic volume is the lowest (lower third). According to the transmission probability table 633-2 indicated in FIG. 23, a transmission probability ratio is “10 to 0”. Accordingly, the node 600 determines that a transmission probability for one path is changed to 100% and that a transmission probability for the other path is changed to 0%.

(Step S72) The node 600 sets wait time to 0 and changes the transmission probabilities for the paths “A-1” and “A-2” in the section “A” to “100%” and “0%” respectively.

(Step S73) The node 600d receives the response message.

(Step S74) The node 600d determines wait time on the basis of a related section number and the rank of a traffic volume indicated in the response message. According to the wait time table 633-1 indicated in FIG. 23, wait time for the node 600d for which the rank of a traffic volume is “1” is “4 minutes”.

(Step S75) The node 600d determines transmission probabilities on the basis of the related section number and the rank of a traffic volume indicated in the response message. The related section number is “4” (greater than three) and the rank of a traffic volume is first (upper third). According to the transmission probability table 633-2 indicated in FIG. 23, a transmission probability ratio is “8 to 2”. Accordingly, the node 600d determines that a transmission probability for one path is changed to 80% and that a transmission probability for the other path is changed to 20%.

(Step S76) After the elapse of four minutes from the detection of the equilibrium state, the node 600d checks whether or not the section “E” is still in an equilibrium state. If the equilibrium state is already canceled, then step S77 is not performed and the process ends. If the equilibrium state is not yet canceled, then the node 600d proceeds to step S77.

(Step S77) The node 600d changes the transmission probabilities for the paths “E-1” and “E-2” in the section “E” to “80%” and “20%” respectively.

The equilibrium state is canceled through the above procedure.

As indicated in FIG. 26, each of the nodes 600, 600a, 600b, 600c, and 600d which function as entry nodes performs an equilibrium determination process. When the node 600, 600a, 600b, 600c, or 600d determines that the section “A,” “B,” “C,” “D,” or “E” has gone into an equilibrium state, it transmits an equilibrium notice message.

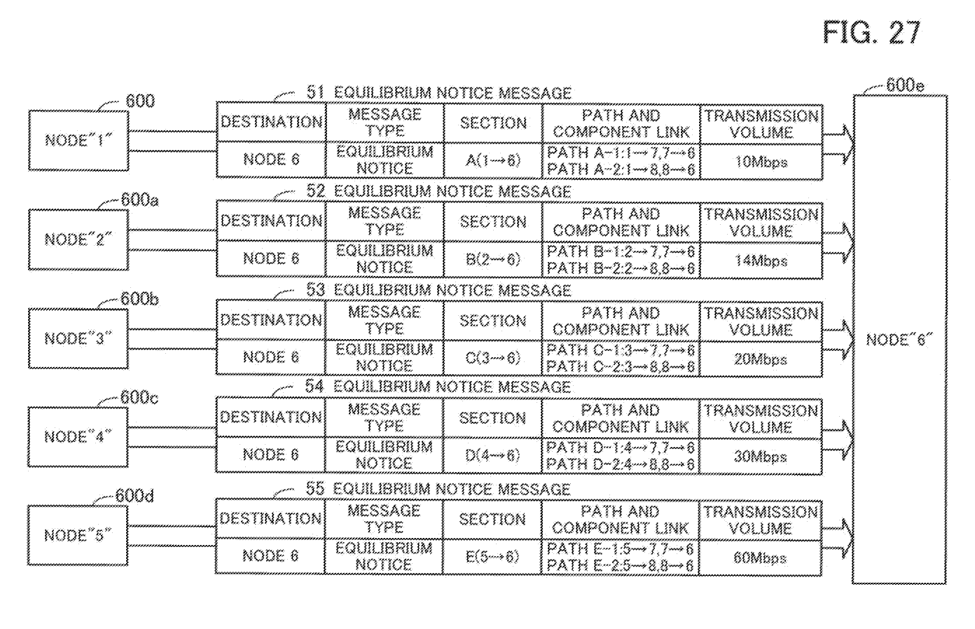

FIG. 27 is an example of an equilibrium notice message transmitted from an entry node to an exit node. As indicated in FIG. 27, the nodes 600, 600a, 600b, 600c, and 600d transmit equilibrium notice messages 51 through 55, respectively, to the node 600e. Each of the equilibrium notice messages 51 through 55 includes Destination, Message Type, Section, Path and Component Link, and Transmission Volume fields.

Node ID of a destination node of each of the equilibrium notice messages 51 through 55 is set in the Destination field. Information (equilibrium notice) indicative of an equilibrium notice message is set in the Message Type field. Section ID of a section for which the determination that an equilibrium state has arisen is made is set in the Section field. Path ID of each path in a section which has gone into an equilibrium state and link information indicative of links which make up each path are set in the Path and Component Link field. Link information is a combination of node ID of a node of a link of a route of a path from which traffic is sent out and node ID of a node of the link of the route of the path into which the traffic flows. A traffic volume in a section which has gone into an equilibrium state is set in the Transmission Volume field.

That is to say, statistical information for the volume of traffic the destination of which is the node 600e that functions as an exit node is included in the equilibrium notice messages 51 through 55. The node 600e receives the equilibrium notice messages 51 through 55. There is a very strong possibility that the equilibrium notice messages 51 through 55 might not reach at the same time. Accordingly, after the node 600e receives the first equilibrium notice message, the node 600e waits a certain period of time for the other equilibrium notice messages to reach. The node 600e then recognizes the following information from the contents of all the equilibrium notice messages 51 through 55 which the node 600e receives in the certain period of time.

First, the node 600e recognizes that the node ID “5,” “4,” “3,” “2,” and “1” come in descending order of traffic volume.

Secondly, the node 600e recognizes that there are four sections (links 7→6 and 8→6 are common) related to the node 600 the node ID of which is “1”. Similarly, the node 600e recognizes that there are four sections (links 7→6 and 8→6 are common) related to each of the nodes 600a, 600b, 600c, and 600d the node ID of which is “2,” “3,” “4,” and “5” respectively.

The node 600e then transmits response messages to the nodes 600, 600a, 600b, 600c, and 600d which transmit the equilibrium notice messages 51 through 55, respectively, thereto.

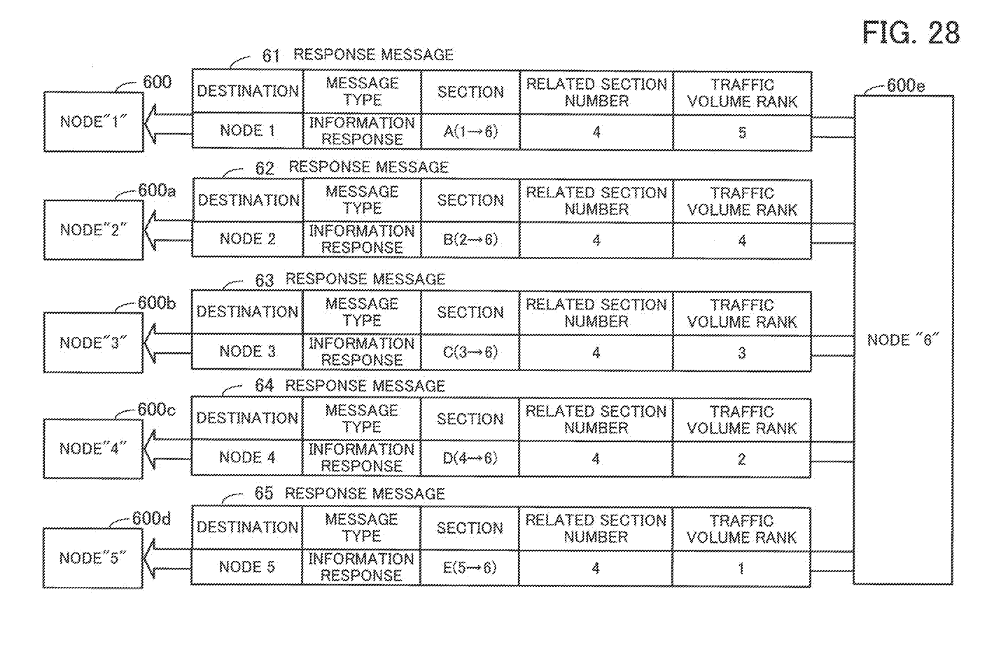

FIG. 28 is an example of a response message. As indicated in FIG. 28, each of response messages 61 through includes Destination, Message Type, Section, Related Section Number, and Traffic Volume Rank fields.

Node ID of a destination node of each of the response messages 61 through 65 is set in the Destination field. Information (information response) indicative of a response message for returning information as a response to equilibrium notice is set in the Message Type field. Section ID of a section for which the determination that an equilibrium state has arisen is made is set in the Section field. The number (related section number) of sections related to a corresponding section is set in the Related Section Number field. A numeric value (traffic volume rank) indicative of the rank of a traffic volume in a corresponding section among sections in which the node 600e functions as an exit node and which have gone into an equilibrium state is set in the Traffic Volume Rank field.

The nodes 600, 600a, 600b, 600c, and 600d which function as entry nodes receive the response messages 61 through 65 respectively. Each of the nodes 600, 600a, 600b, 600c, and 600d then determines wait time and a transmission probability for each path after a change on the basis of the wait time table 633-1 and the transmission probability table 633-2 indicated in FIG. 23. That is to say, a node at which a traffic volume is lower performs a transmission probability change process for equilibrium cancellation earlier. In addition, a node at which a traffic volume is lower makes the difference between transmission probabilities after a change larger. As a result, when the response messages 61 through 65 are transmitted to the nodes 600, 600a, 600b, 600c, and 600d respectively, the node 600 performs a transmission probability change process first.

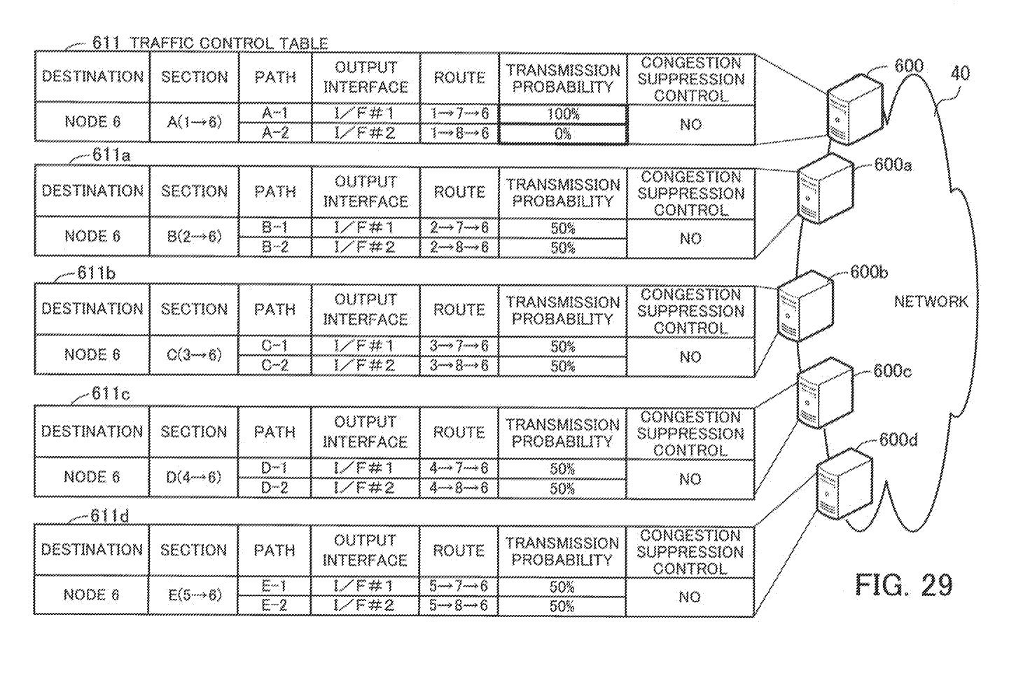

FIG. 29 indicates a state in which the node the node ID of which is “1” has changed the transmission probabilities. A traffic volume at the node 600 is the lowest. Therefore, as indicated in FIG. 29, the node 600 immediately changes the transmission probabilities for the paths “A-1” and “A-2” so that a transmission probability ratio will be 10 to 0. That is to say, the transmission probabilities for the paths “A-1” and “A-2” have been changed to “100%” and “0%” respectively.

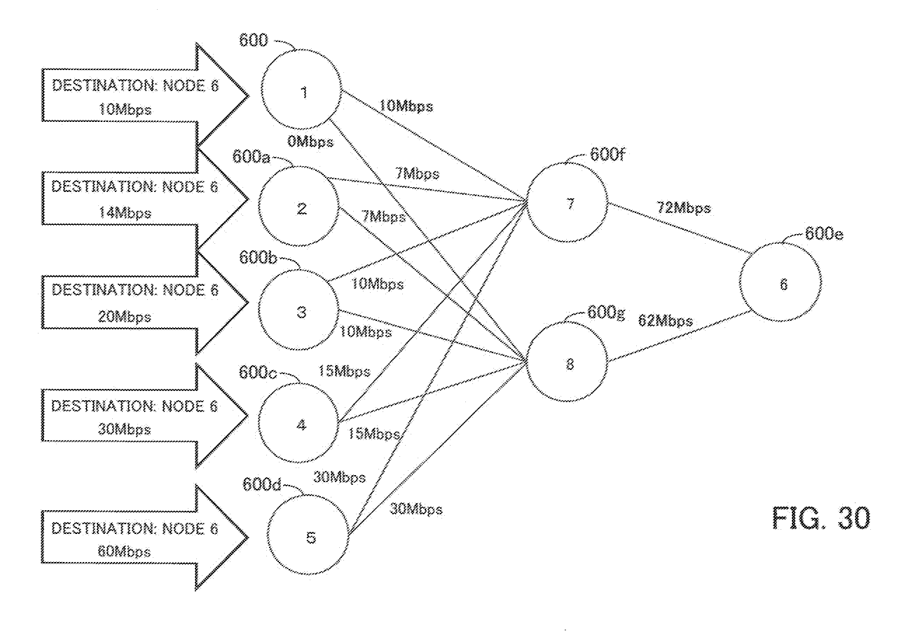

FIG. 30 illustrates a traffic volume on each link after the change in transmission probability made by the node the node ID of which is “1”. The node 600 has changed the transmission probabilities. That is to say, a traffic volume on the link from the node 600 to the node 600f becomes 10 Mbps and a traffic volume on the link from the node 600 to the node 600g becomes 0 Mbps. As a result, a traffic volume on the link from the node 600f to the node 600e increases to 72 Mbps and a traffic volume on the link from the node 600g to the node 600e decreases to 62 Mbps. It is assumed that a threshold on each link at which congestion suppression control is begun is 80 Mbps.

The link from the node 600f to the node 600e and the link from the node 600g to the node 600e are probabilities are changed and the sections “B,” “C,” “D,” and “E”. Accordingly, the nodes 600a, 600b, 600c, and 600d are informed of attraction changed because of the increase in traffic volume on the link from the node 600f to the node 600e or the decrease in traffic volume on the link from the node 600g to the node 600e. The nodes 600a, 600b, 600c, and 600d then change the transmission probabilities in the sections which are in an equilibrium state according to the attraction of which the nodes 600a, 600b, 600c, and 600d are informed. It is assumed that an attraction calculation method is the same with the second embodiment. In this case, a change in transmission probability for each path in the sections “B,” “C,” “D,” and “E” is as follows.

paths “B-1,” “C-1,” “D-1,” and “E-1”: 52.4%

paths “B-2,” “C-2,” “D-2,” and “E-2”: 47.6%

Such a change in transmission probability causes a further change in traffic volume.

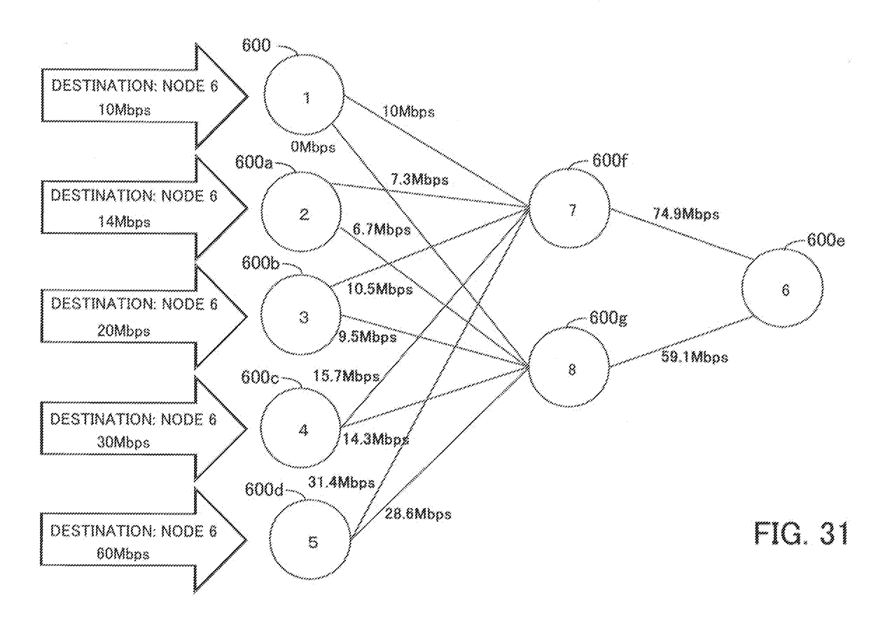

FIG. 31 illustrates a traffic volume on each link after a change in transmission probability made by each of the nodes the node ID of which are “2,” “3,” “4,” and “5”. A traffic volume on the link from the node 600a to the node 600f is 7.3 Mbps and a traffic volume on the link from the node 600a to the node 600g is 6.7 Mbps. A traffic volume on the link from the node 600b to the node 600f is 10.5 Mbps and a traffic volume on the link from the node 600b to the node 600g is 9.5 Mbps. A traffic volume on the link from the node 600c to the node 600f is 15.7 Mbps and a traffic volume on the link from the node 600c to the node 600g is 14.3 Mbps. A traffic volume on the link from the node 600d to the node 600f is 31.4 Mbps and a traffic volume on the link from the node 600d to the node 600g is 28.6 Mbps. As a result, a traffic volume on the link from the node 600f to the node 600e increases to 74.9 Mbps and a traffic volume on the link from the node 600g to the node 600e decreases to 59.1 Mbps.

As illustrated in FIG. 31, when one entry node performs equilibrium cancellation operation, the attraction of each link in the network is updated. There is a change in transmission probability. That is to say, a transmission probability for a path through the node 600f becomes higher than a transmission probability for a path through the node 600g. As a result, the equilibrium state of all the sections is canceled.

In the third embodiment, as has been described, the nodes perform equilibrium cancellation operation in ascending order of traffic volume. Furthermore, the number of related sections is four and therefore large. Accordingly, equilibrium cancellation operation performed by a node at which a traffic volume is low causes a slight change in entire traffic volume on the links common to the node and the other nodes. As a result, even if a transmission probability ratio is changed extremely to “10 to 0,” the risk of the occurrence of congestion is low. In addition, by extremely changing a transmission probability ratio to “10 to 0,” traffic can be centralized early. If the degree of a change in transmission probability ratio is small in a section in which a traffic volume is low, only a slight change can be caused. It takes a long time to destroy a balance and bring about a centralized state. However, in the case where there is no related section, for example, an extreme change may cause a significant change in traffic volume. Therefore, it is proper to change a transmission probability ratio to, for example, “8 to 2”.

In the third embodiment it is assumed that the nodes perform equilibrium cancellation operation in descending order of traffic volume and that a transmission probability ratio is changed to “8 to 2” in the section “E” in which a transmission volume is 60 Mbps. A traffic volume on the link “7→6” increases suddenly to 85 Mbps and exceeds the threshold of congestion suppression control. Therefore, when equilibrium cancellation operation is performed on a section in which a traffic volume is high, there is a strong possibility of a transient deterioration in quality. However, if the degree of a change in transmission probability ratio is large, time taken to destroy a balance and bring about a centralized state is short. These parameters can be adjusted by the operator's policy.

### Fourth Embodiment

A fourth embodiment will now be described. In the fourth embodiment an exit node which receives an equilibrium notice message determines timing at which an entry node performs equilibrium cancellation operation and the contents of a change and informs the entry node of a determination result. That is to say, in the above third embodiment an entry node which receives a response determines timing at which it performs equilibrium cancellation operation and the contents of a change. In the fourth embodiment, however, an exit node determines them in block. The exit node manages the timing of equilibrium cancellation operation and the like in block in this way. In addition to the method of performing equilibrium cancellation operation in descending or ascending order of traffic volume, more reliable control can be exercised. For example, it is possible to select a section in which equilibrium cancellation operation is performed and to determine a transmission probability ratio after a change so as to cancel an equilibrium state without deteriorating quality.

In the fourth embodiment it is assumed that an entry node which performs equilibrium cancellation operation is determined by the use of an accommodable remaining volume of each section which has gone into an equilibrium state. An accommodable remaining volume of a section is the minimum value of accommodable remaining volumes of paths in the section. An accommodable remaining volume of a path is the minimum value of accommodable remaining volumes of links included in the path. Accordingly, an accommodable remaining volume of the section is the minimum value of accommodable remaining volumes of all links included in the paths in the section.

An accommodable remaining volume of a link is a value obtained by subtracting a traffic volume from an accommodable volume of the link.

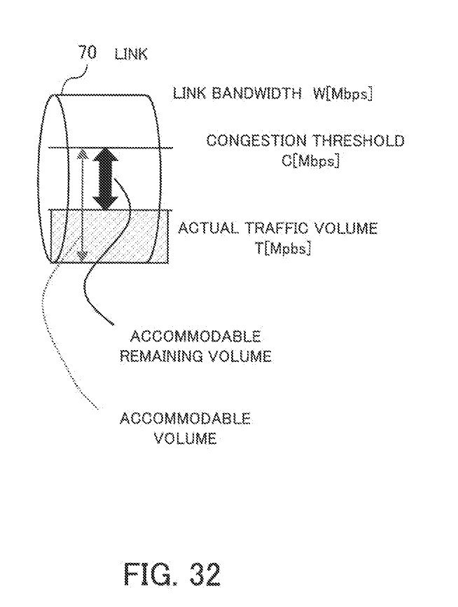

FIG. 32 is a view for describing an accommodable remaining volume. A link bandwidth W of a link 70 is determined. The link bandwidth W is the maximum of the volume of traffic which can be transmitted along the link 70. However, when the volume of traffic which flows into the link 70 exceeds the link bandwidth W, congestion occurs. Accordingly, a congestion threshold C which is a value smaller than the link bandwidth W is set. The congestion threshold C is, for example, a value obtained by multiplying (link bandwidth W) and 0.8 together. When a traffic volume T reaches the congestion threshold C, congestion suppression control is begun. Therefore, a traffic volume which does not exceed the congestion threshold C is defined as the accommodable volume of the link 70. The difference between the accommodable volume and the actual traffic volume T is an accommodable remaining volume.

Such an accommodable remaining volume can be calculated according to link. The minimum value of accommodable remaining volumes of all links included in each path in a section is an accommodable remaining volume of the section. In the fourth embodiment an exit node exercises control by the use of an accommodable remaining volume of each section which has gone into an equilibrium state so as to make the difference in traffic volume as much as possible without exceeding a congestion threshold.

The structure of a network in the fourth embodiment is the same as that of the network in the third embodiment illustrated in FIG. 21.

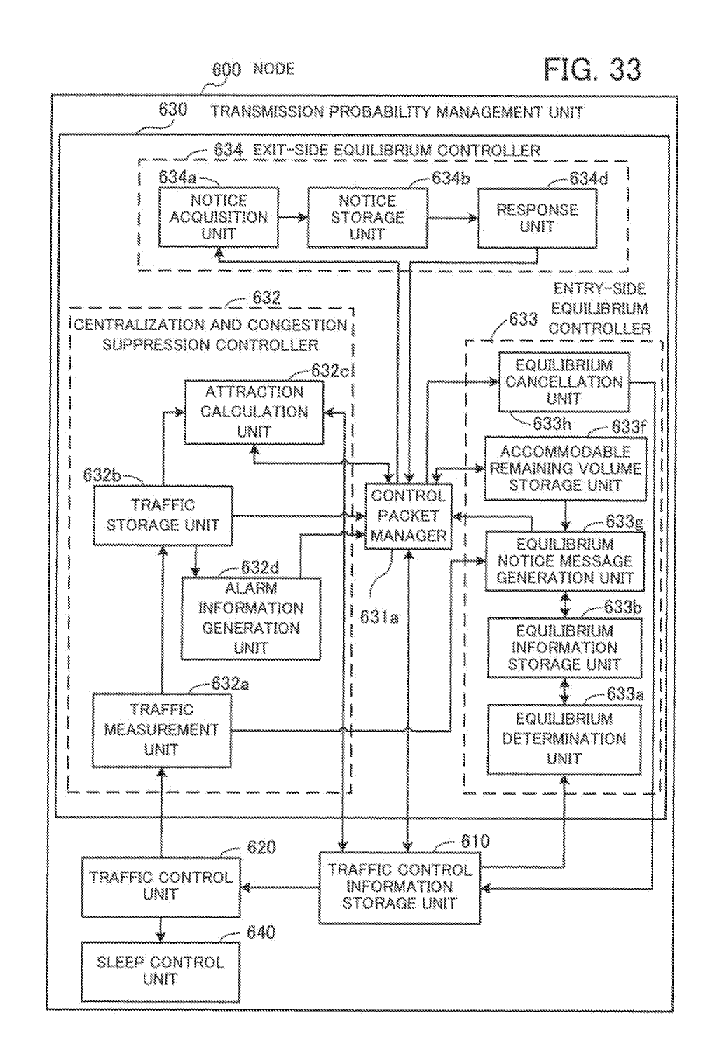

FIG. 33 is a block diagram of the functions of a node in the fourth embodiment. Many of the functions of a node in the fourth embodiment are the same as those of the node in the third embodiment. Accordingly, components which are equal in function to those of FIG. 22 described in the third embodiment are marked with the same symbols and descriptions of them will be omitted.

The functions of a control packet manager 631a, an accommodable remaining volume storage unit 633f, an equilibrium notice message generation unit 633g, an equilibrium cancellation unit 633h, and a response unit 634d differ from those included in the node in the third embodiment.

In addition to the functions of the control packet manager 631 in the third embodiment, the control packet manager 631a has the function of transmitting and receiving the minimum value of an accommodable remaining volume. That is to say, in the fourth embodiment measures to acquire information regarding links (each of which is not connected to an entry node) which make up a path are needed. The control packet manager 631a includes measures to give notice of attraction along a path. Accordingly, when a node 600 functions as an exit node or a relay node, the control packet manager 631a adds information regarding an actual traffic volume on each link to a control packet for giving notice of attraction. By doing so, the control packet manager 631a informs an entry node of a traffic volume on each link. To be concrete, the control packet manager 631a refers to a traffic storage unit 632b and calculates an accommodable remaining volume of a link from an inflow traffic volume, a link bandwidth, and a traffic usage limit value. When the node 600 functions as an exit node, the control packet manager 631a then transmits the calculated accommodable remaining volume of the link as an accommodable remaining volume of a path, together with attraction, to a node connected to the node 600 via the link by a control packet.

When the node 600 functions as a relay node, the control packet manager 631a calculates an accommodable remaining volume of a link between the node 600 and an adjacent node on the entry node side. The control packet manager 631a then compares the calculated accommodable remaining volume of the link with an accommodable remaining volume of a path acquired from an adjacent node on the exit node side. If the calculated accommodable remaining volume of the link is smaller than the acquired accommodable remaining volume of the path, then the control packet manager 631a designates the calculated accommodable remaining volume of the link as an accommodable remaining volume of the path. If the calculated accommodable remaining volume of the link is greater than or equal to the acquired accommodable remaining volume of the path, then the control packet manager 631a determines that the accommodable remaining volume of the path is not changed. The control packet manager 631a then transmits the determined accommodable remaining volume of the path to the adjacent node on the entry node side by a control packet.

In addition, when the node 600 functions as an entry node, the control packet manager 631a extracts an accommodable remaining volume of a path from a control packet which it receives from adjacent node and stores the accommodable remaining volume of the path in the accommodable remaining volume storage unit 633f.

When the node 600 functions as an entry node, the accommodable remaining volume storage unit 633f stores an accommodable remaining volume of a path in each section. For example, a part of a storage area of a RAM or a HDD is used as the accommodable remaining volume storage unit 633f.

In addition to the functions of the equilibrium notice message generation unit 633c in the third embodiment, the equilibrium notice message generation unit 633g has the function of adding an accommodable remaining volume of a section to an equilibrium notice message. That is to say, if the equilibrium notice message generation unit 633g detects a section which has gone into an equilibrium state, then the equilibrium notice message generation unit 633g acquires accommodable remaining volumes of paths in the section from the accommodable remaining volume storage unit 633f. The equilibrium notice message generation unit 633g then adds the minimum value of the acquired accommodable remaining volumes of the paths to an equilibrium notice message as an accommodable remaining volume of the section and transmits the equilibrium notice message to an exit node via the control packet manager 631a.

When the equilibrium cancellation unit 633h receives a response message to the equilibrium notice message from the control packet manager 631a, the equilibrium cancellation unit 633h performs equilibrium cancellation operation according to the contents of the response message. For example, a path transmission probability ratio (probability ratio) in the section which has gone into an equilibrium state is indicated in the response message. If a probability ratio after a change is not indicated in the response message, then the equilibrium cancellation unit 633h does not perform equilibrium cancellation operation.

On the basis of the equilibrium notice message received from the control packet manager 631a, the response unit 634d determines a node which performs equilibrium cancellation operation. At this time the response unit 634d refers to an accommodable remaining volume of each section which has gone into an equilibrium state, and selects a section in which it is possible to make a difference in traffic volume the largest without exceeding a threshold of congestion suppression control. The response unit 634d then designates an entry node of the section as a node which performs equilibrium cancellation operation.

For example, the response unit 634d refers to an estimated traffic increase volume Y obtained at the time of changing an equilibrium state (in which a transmission probability for each path is 50%) to a state in which a transmission probability for one path is 80% and in which a transmission probability for the other path is 20% by the formula

Y=X×(0.8 −0.5) (4)

where X is the volume of traffic which floes into a section.

For example, the response unit 634d selects a section from among sections which have gone into an equilibrium state in descending order of estimated traffic increase volume Y, and compares an estimated traffic increase volume Y of the section with an accommodable remaining volume of the section. If the estimated traffic increase volume Y of the selected section is smaller than the accommodable remaining volume of the selected section, then the response unit 634d designates an entry node of the selected section as a node which performs equilibrium cancellation operation.

The response unit 634d transmits a response message in which a transmission probability ratio at equilibrium cancellation operation time is designated to the entry node which performs equilibrium cancellation operation via the control packet manager 631a. In addition, the response unit 634d transmits a response message which does not include a transmission probability ratio at equilibrium cancellation operation time to an entry node other than the entry node which performs equilibrium cancellation operation via the control packet manager 631a.

FIG. 33 illustrates the functions of the node 600. However, nodes 600a, 600b, 600c, 600d, 600e, 600f, and 600g have the same functions.

The data format of a control packet (state notice control packet) used for giving notice of an accommodable remaining volume of a path will now be described.

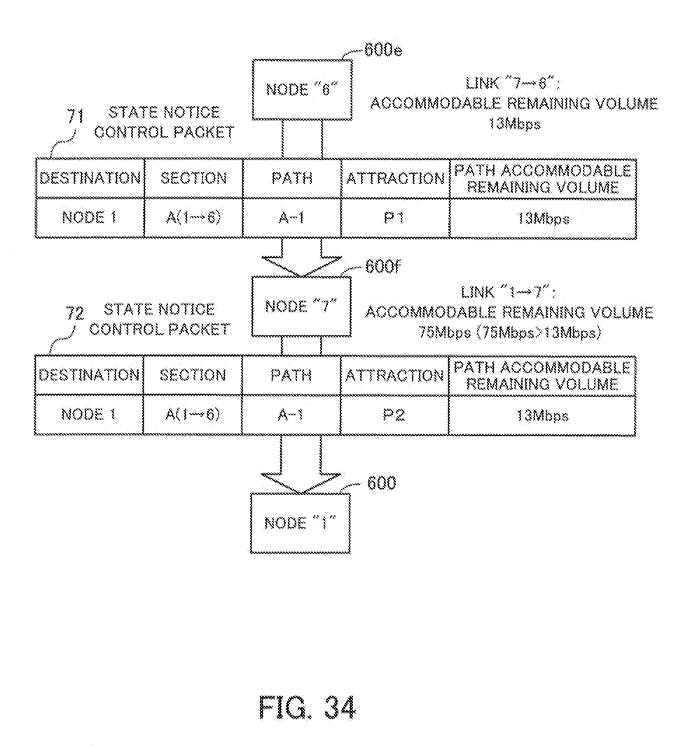

FIG. 34 is an example of a state notice control packet. An accommodable remaining volume of a path obtained in the case of the traffic illustrated in FIG. 24 flowing is indicated in state notice control packets 71 and 72 illustrated in FIG. 34.

As illustrated in FIG. 34, each of the state notice control packets 71 and 72 includes Destination, Section, Path, Attraction, and Path Accommodable Remaining Volume fields. Node ID of a node which is a destination of the state notice control packet 71 or 72 is set in the Destination field. Section ID of a section notice of the state of which is given is set in the Section field. Path ID of a path notice of the state of which is given is set in the Path field. The attraction of a link between a node and an adjacent node on the entry node side is set in the Attraction field. The minimum value of accommodable remaining volumes of links on routes from an exit node to nodes is set in the Path Accommodable Remaining Volume field as an accommodable remaining volume of a path.

For example, the node 600e which functions as an exit node calculates an accommodable remaining volume of a link (link “7→6”) from the node 600f to the node 600e. According to FIG. 24, a traffic volume on the link “7→6” is 67 Mbps. It is assumed that a link bandwidth of each link is 100 Mbps and that a congestion threshold is 80 Mbps. Then an accommodable remaining volume of the link “7→6” is 13 Mbps. As a result, 13 Mbps is set as an accommodable remaining volume of a path in the state notice control packet 71 transmitted from the node 600e to the node 600f.

The node 600f which functions as a relay node calculates an accommodable remaining volume of a link (link “1→7”) from the node 600 to the node 600f. According to FIG. 24, a traffic volume on the link “1→7” is 5 Mbps. Then an accommodable remaining volume of the link “1→7” is 75 Mbps. The accommodable remaining volume of the link calculated by the node 600f is greater than the accommodable remaining volume of the path of which the node 600e informs the node 600f. Accordingly, the node 600f transmits the state notice control packet 72 to the node 600 without updating the accommodable remaining volume of the path.

Each node calculates attraction and attraction indicated in the state notice control packet 71 or 72 is updated. As a result, the attraction “P1” of which the node 600e informs the node 600f is changed to the attraction “P2” calculated by the node 600f.

The node 600 which receives the state notice control packet 72 stores the accommodable remaining volume of the path in the accommodable remaining volume storage unit 633f. On the basis of the state notice control packet 72, the node 600 which functions as an entry node recognizes that the accommodable remaining volume of the path “A-1” is 13 Mbps.

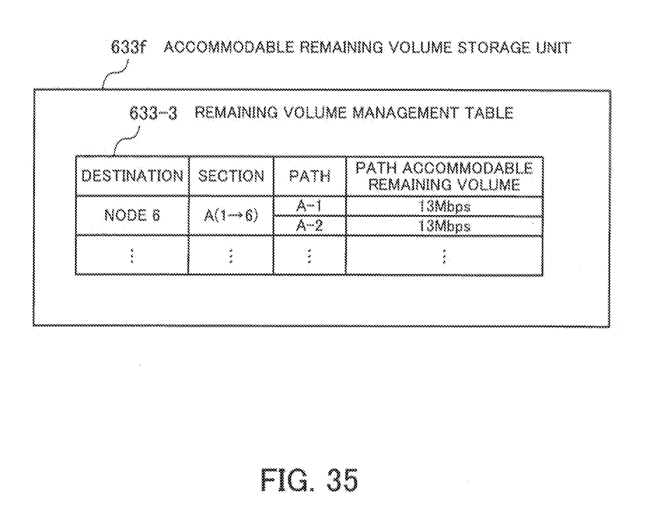

FIG. 35 illustrates an example of the data structure of the accommodable remaining volume storage unit. A remaining volume management table 633-3 is stored in the accommodable remaining volume storage unit 633f. The remaining volume management table 633-3 includes Destination, Section, Path, and Path Accommodable Remaining Volume columns.

Node ID of an exit node of a section is set in the Destination column. Section ID of a section is set in the Section column. Path ID of a path set in a section is set in the Path column. An accommodable remaining volume of a path is set in the Path Accommodable Remaining Volume column.

If there is a section which has gone into an equilibrium state, then the equilibrium notice message generation unit 633g refers to the remaining volume management table 633-3 and can determine the accommodable remaining volume of the section. That is to say, the equilibrium notice message generation unit 633g considers the minimum value of the accommodable remaining volumes of paths in the section which has gone into an equilibrium state as the accommodable remaining volume of the section.

A procedure for a process performed in the fourth embodiment in the case where an equilibrium state like that illustrated in FIG. 24 arises will now be described.

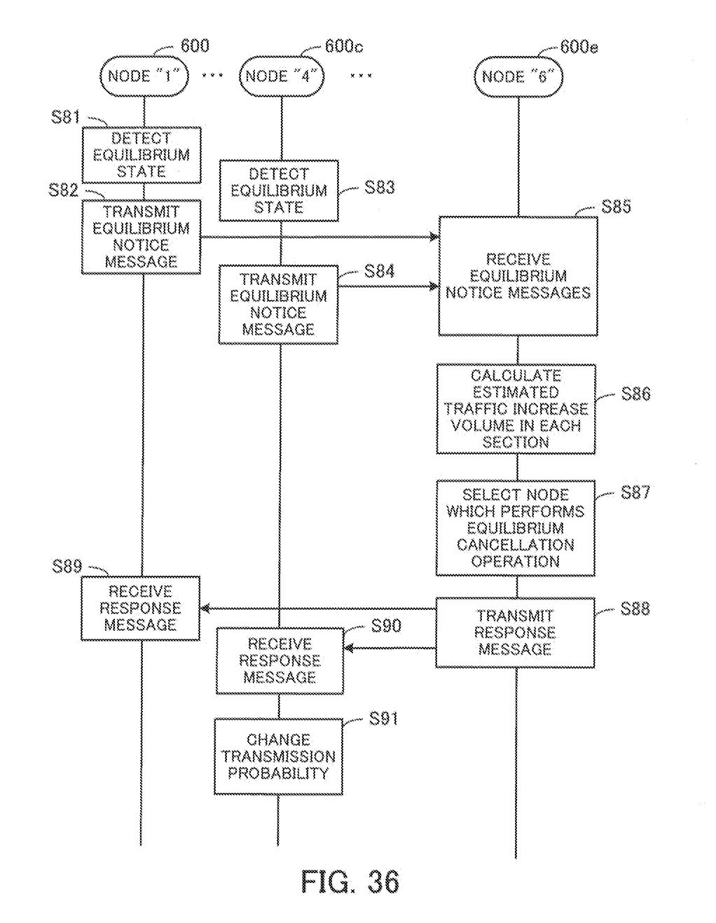

FIG. 36 is a sequence diagram of an example of a procedure for an equilibrium cancellation process in the fourth embodiment. In the example of FIG. 36, processes performed by the nodes 600 and 600c of the five entry nodes are typically indicated. The processes illustrated in FIG. 36 will now be described in order of step number.

(Step S81) The node 600 detects an equilibrium state of the section “A”.

(Step S82) The node 600 transmits an equilibrium notice message which is indicative that the section “A” has gone into an equilibrium state to the node 600e which functions as an exit node. At this time an accommodable remaining volume of the section “A” is added to the equilibrium notice message.

(Step S83) The node 600c detects an equilibrium state of the section “D”.

(Step S84) The node 600c transmits an equilibrium notice message which is indicative that the section “D” has gone into an equilibrium state to the node 600e which functions as an exit node. At this time an accommodable remaining volume of the section “D” is added to the equilibrium notice message.

(Step S85) The node 600e receives the equilibrium notice messages transmitted from the nodes 600 and 600c.The node 600e stores the received equilibrium notice messages in a notice storage unit 634b. The time when an equilibrium notice message is transmitted from each node differs in some degree. Accordingly, after the node 600e receives the first equilibrium notice message, the node 600e waits for a determined period of time. After that, the node 600e proceeds to step S86.

(Step S86) The node 600e calculates an estimated traffic increase volume in each section which has gone into an equilibrium state by the use of the above formula (4).

(Step S87) The node 600e selects a node which performs equilibrium cancellation operation. To be concrete, of sections in which congestion suppression control is not begun even in the case of a difference in traffic volume being set at a determined ratio (8 to 2, for example), the node 600e selects an entry node of a section in which an estimated traffic increase volume is the highest as a node which performs equilibrium cancellation operation. In the example of FIG. 36, the node 600c is selected as a node which performs equilibrium cancellation operation.

(Step S88) The node 600e transmits a response message to each node which transmits an equilibrium notice message to the node 600e. At this time the node 600e transmits a response message in which a path transmission probability ratio after a change is designated to the node 600c which performs equilibrium cancellation operation. In addition, the node 600e transmits a response message in which a path transmission probability ratio after a change is not designated to the node 600 different from the node 600c which performs equilibrium cancellation operation.

(Step S89) The node 600 receives the response message. A path transmission probability ratio is not designated in the response message received by the node 600, so the node 600 terminates the process without performing equilibrium cancellation operation.

(Step S90) The node 600c receives the response message. The path transmission probability ratio is designated in the response message received by the node 600c, so the node 600c proceeds to step S91.

(Step S91) The node 600c changes a transmission probability for each path in the section “D” in accordance with the path transmission probability ratio designated in the response message. If wait time is designated in the response message, then the node 600c changes a transmission probability for each path in the section “D” after the elapse of the designated wait time.

The equilibrium state is canceled through the above procedure.

The contents of an equilibrium notice message transmitted from an entry node to an exit node will now be described in detail.

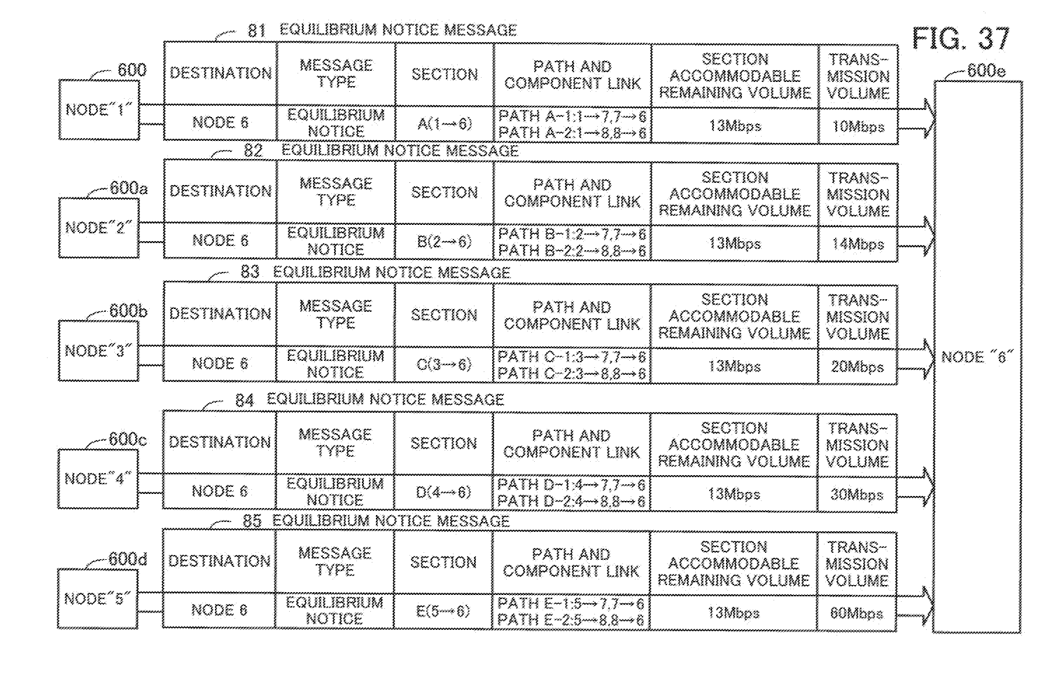

FIG. 37 is an example of an equilibrium notice message transmitted from an entry node to an exit node. When an equilibrium state like that illustrated in FIG. 24 arises, equilibrium notice messages 81 through 85 are transmitted from the nodes 600, 600a, 600b, 600c, and 600d, respectively, which function as entry nodes to the node 600e which functions as an exit node. The equilibrium notice messages 81 through 85 in the fourth embodiment are obtained by adding Section Accommodable Remaining Volume fields to the equilibrium notice messages 51 through 55, respectively, in the third embodiment indicated in FIG. 27.

An accommodable remaining volume of a section which has gone into an equilibrium state is set in the Section Accommodable Remaining Volume field. In the example of FIG. 37, accommodable remaining volumes of all the sections “A,” “B,” “C,” “D,” and “E” are 13 Mbps.

The node 600e which receives the above equilibrium notice messages 81 through 85 determines a section in which it is possible to make the difference in traffic volume as much as possible without exceeding 13 Mbps. It is assumed that a path transmission probability ratio set by equilibrium cancellation operation is 8 to 2. The node 600e calculates the estimated traffic increase volume Y according to section by the use of formula (4). The node 600e then selects a section in which the estimated traffic increase volume Y is the highest without exceeding the accommodable remaining volume of 13 Mbps.

In the example of FIG. 37, an estimated traffic increase volume in the section “A” is 3 Mbps. An estimated traffic increase volume in the section “B” is 4.2 Mbps. An estimated traffic increase volume in the section “C” is 6 Mbps. An estimated traffic increase volume in the section “D” is 9 Mbps. An estimated traffic increase volume in the section “E” is 18 Mbps.

If a path transmission probability ratio is set to 8 to 2 (transmission probability for one path is 80% and transmission probability for the other path is 20%) in the section “E,” then the estimated traffic increase volume exceeds the accommodable remaining volume. Accordingly, of the sections “A” through “D,” the section “D” in which the estimated traffic increase volume is the highest is selected. The node 600c which functions as an entry node of the section “D” is designated as a node which performs equilibrium cancellation operation.

The node 600e then transmits a response message in which a path transmission probability ratio after a change and wait time are designated only to the node 600c. The node 600e transmits to the other nodes 600, 600a, 600b, and 600d response messages in which the node 600e gives instructions to do nothing.

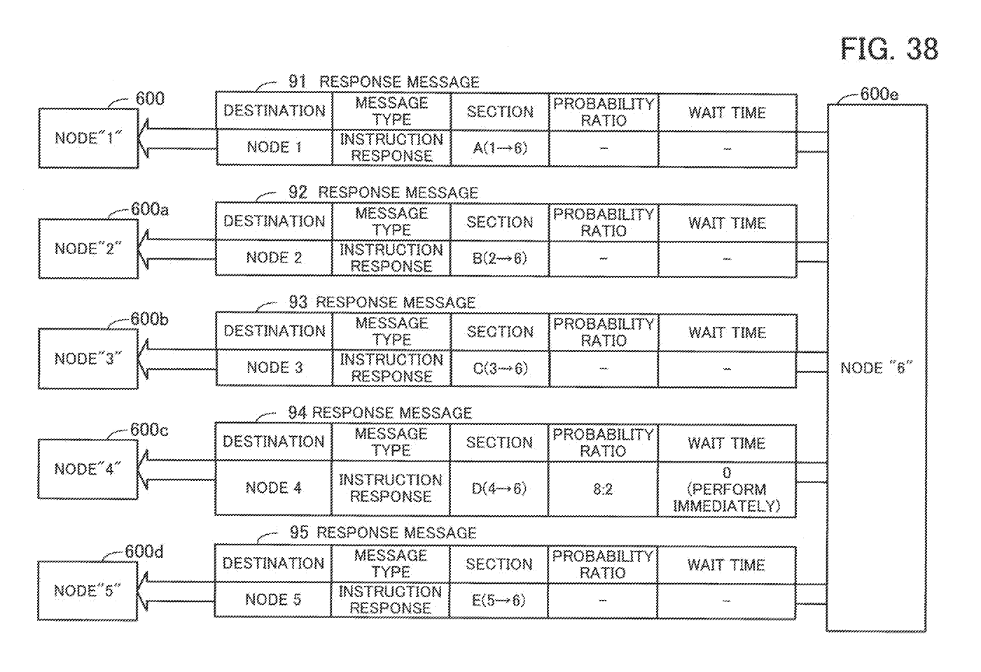

FIG. 38 is an example of the response message in the fourth embodiment. As indicated in FIG. 38, each of response messages 91 through 95 includes Destination, Message Type, Section, Probability Ratio, and Wait Time fields.

Node ID of a destination node of each of the response messages 91 through 95 is set in the Destination field. Information (instruction response) indicative of a response message for returning instructions as a response to equilibrium notice is set in the Message Type field. Section ID of a section for which the determination that an equilibrium state has arisen is made is set in the Section field. A path transmission probability ratio set at equilibrium cancellation operation time is set in the Probability Ratio field. Wait time to the performing of equilibrium cancellation operation is set in the Wait Time field.

In the example of FIG. 38, a probability ratio is set only in the response message 94 transmitted to the node 600c.As a result, only the node 600c performs equilibrium cancellation operation by which transmission probabilities for paths in the section in an equilibrium state are changed (to 80% and 20%) according to the probability ratio.

As described in the above example, the node 600e may select only one node as a node which performs equilibrium cancellation operation. Alternatively, the node 600e may select a plurality of nodes as nodes which perform equilibrium cancellation operation. If the node 600e selects a plurality of nodes, the node 600e may set a difference in wait time designated in response messages so that an entry node of a section in which an estimated traffic increase volume is higher will perform equilibrium cancellation operation earlier.

In addition, if the node 600e selects a plurality of nodes as nodes which perform equilibrium cancellation operation, the node 600e may inform the plurality of nodes of different probability ratios. For example, the node 600e may inform an entry node of a section in which a transmission volume is low of a probability ratio of “10 to 0”.

As has been described, an exit node gives detailed instructions as to equilibrium cancellation operation. As a result, it is possible to cancel an equilibrium state rapidly while maintaining communication quality.

### Other Embodiments

In the above example, time for which traffic is in a distributed state is gauged by the distributed state counter. However, time may be gauged by another method. For example, one method is to record the time when traffic goes into a distributed state and to monitor time which elapses from that time. Furthermore, if a transmission probability for each path in a section does not change for a certain period of time, then the determination that the section is in an equilibrium state may be made.

The attraction of a path can be defined in various ways so that the attraction of a route on which a load is heavy will become strong.

The above functions can be realized with a computer. In this case, a program in which the contents of the functions each node should have are described is provided. By executing this program on the computer, the above functions are realized on the computer. This program can be recorded on a computer readable record medium. A computer readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a DVD, a DVD-RAM, a CD-ROM/RW, or the like. A magneto-optical recording medium can be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When the computer executes this program, it will store the program, which is recorded on a portable record medium or which is transferred from the server computer, on, for example, its hard disk. Then the computer reads the program from its hard disk and performs processes in compliance with the program. The computer can also read the program directly from a portable record medium and perform processes in compliance with the program. Furthermore, each time the program is transferred from the server computer, the computer can perform processes in turn in compliance with the program it receives.

In addition, al least a part of the above functions can be realized with an electronic circuit such as a DSP (Digital Signal Processor), an ASIC (Application Specific Integrated Circuit), or a PLD (Programmable Logic Device).

According to the art disclosed herein, even if traffic goes into an equilibrium state on a plurality of routes, the traffic can be centralized by autonomous control.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A data transmission apparatus for transmitting data a destination of which is an apparatus connected thereto via a network via any of a plurality of routes in the network, the data transmission apparatus comprising:
a plurality of communication interfaces corresponding to the plurality of routes;
a storage unit configured to store a usage percentage indicative of a percentage by which each of the plurality of routes is used for transmitting the data the destination of which is the apparatus; and
a processor configured
to refer to the storage unit and to distribute the data the destination of which is the apparatus to routes according to the usage percentage of each route to transmit the data the destination of which is the apparatus,
to lower the usage percentage of a route on which a data transmission load is light compared with other routes, the usage percentage being set in the storage unit,
to determine, in the case of a state in which the usage percentages of two or more routes are greater than a determined value continuing for a determined period of time, that an equilibrium state has arisen, and
to set usage percentages of the two or more routes between which there is a difference in the storage unit in the case of the determination that an equilibrium state has arisen being made.

2. The data transmission apparatus according to claim 1, wherein if the determination that transmission of the data the destination of which is the apparatus is in an equilibrium state is made and a symptom of congestion is not detected on any of the plurality of routes, then the processor is configured to set usage percentages of routes between which there is a difference in the storage unit.

3. The data transmission apparatus according to claim 1, wherein:
the processor is configured to determine wait time from the time when the determination that transmission of the data the destination of which is the apparatus is in an equilibrium state is made; and
after the elapse of the wait time the processor is configured to set usage percentages of routes between which there is a difference in the storage unit.

4. The data transmission apparatus according to claim 3, wherein:
if after the arising of the equilibrium state the data the destination of which is the apparatus is sent out to the two or more routes between the usage percentages of which there is a difference greater than or equal to a determined value, then the processor is configured to determine that the equilibrium state is canceled; and
if the determination that transmission of the data the destination of which is the apparatus is in an equilibrium state is made and the equilibrium state is not canceled before the elapse of the wait time, then the processor is configured to set usage percentages of routes between which there is a difference in the storage unit.

5. The data transmission apparatus according to claim 3, wherein the processor is configured to set time randomly generated as the wait time.

6. The data transmission apparatus according to claim 3, wherein:
if transmission of the data the destination of which is the apparatus has gone into an equilibrium state, then the processor is configured to give the apparatus notice that transmission of the data the destination of which is the apparatus has gone into an equilibrium state; and
the processor is configured to determine the wait time according to contents of a response from the apparatus to the notice.

7. The data transmission apparatus according to claim 6, wherein:
the processor is configured to acquire rank of the data transmission apparatus obtained by ranking of a plurality of equilibrium state apparatus which give the apparatus notice that transmission of the data the destination of which is the apparatus has gone into an equilibrium state on the basis of a volume of traffic the destination of which is the apparatus from the apparatus; and
the processor is configured to determine the wait time according to the rank.

8. The data transmission apparatus according to claim 1, wherein:
if transmission of the data the destination of which is the apparatus has gone into an equilibrium state, then the processor is configured to give the apparatus notice that transmission of the data the destination of which is the apparatus has gone into an equilibrium state; and
the processor is configured to determine a degree of a difference between usage percentages of the two or more routes according to contents of a response from the apparatus to the notice.

9. The data transmission apparatus according to claim 8, wherein:
the processor is configured to acquire rank of the data transmission apparatus obtained by ranking of a plurality of equilibrium state apparatus which give the apparatus notice that transmission of the data the destination of which is the apparatus has gone into an equilibrium state on the basis of a volume of traffic the destination of which is the apparatus from the apparatus; and
the processor is configured to determine a degree of a difference between usage percentages of the two or more routes according to the rank.

10. The data transmission apparatus according to claim 9, wherein:
the processor is configured to acquire rank of the data transmission apparatus obtained by ranking of related apparatus of the plurality of equilibrium state apparatus each of which transmits data to the apparatus via a route at least a part of which is included in the plurality of routes on the basis of a volume of traffic the destination of which is the apparatus and a number of the related apparatus from the apparatus; and
the processor is configured to determine a degree of a difference between usage percentages of the two or more routes according to the number of the related apparatus and the rank.

11. A data receiving apparatus for receiving data from an apparatus connected thereto via a network via any of a plurality of routes in the network, the data receiving apparatus comprising:
a plurality of communication interfaces corresponding to the plurality of routes;
a storage unit; and
a processor configured
to acquire from a plurality of apparatus notice that transmission of data a destination of which is the data receiving apparatus is in an equilibrium state and to store the notice in the storage unit, the equilibrium state meaning that a state in which there are two or more routes a usage percentage of each of which is greater than a determined value continues for a determined period of time, the usage percentage indicating a percentage by which a route is used for data transmission, the notice including an amount of transmitted data the destination of which is the data receiving apparatus, and
to refer to the storage unit, to determine contents of responses destinations of which are the plurality of apparatus on the basis of an amount of data transmitted from each of the plurality of apparatus to the data receiving apparatus, and to transmit the contents of the responses determined to the plurality of apparatus.

12. The data receiving apparatus according to claim 11, wherein the processor is configured to perform ranking of the plurality of apparatus in descending order of amount of data transmitted from the plurality of apparatus to the data receiving apparatus and to give the plurality of apparatus notice of rank.

13. The data receiving apparatus according to claim 11, wherein the processor is configured to give notice of rank of the apparatus and a number of related apparatus each of which transmits data to the data receiving apparatus via a route at least a part of which is included in the plurality of routes, the rank of the apparatus being obtained by ranking of the related apparatus on the basis of a volume of traffic a destination of which is the data receiving apparatus.

14. The data receiving apparatus according to claim 11, wherein the processor is configured to select at least one of the plurality of apparatus which send the notice and to give the selected apparatus instructions to change usage percentages of the plurality of routes which can be used for transmitting data a destination of which is the data receiving apparatus, there being a difference between the usage percentages.

15. The data receiving apparatus according to claim 14, wherein of apparatus which do not begin congestion suppression control in the case of there being a determined difference between the usage percentages of the plurality of routes which can be used for transmitting data the destination of which is the data receiving apparatus, the processor is configured to select an apparatus for which a traffic increase volume is high on a route on which a traffic volume increases in the case of there being the determined difference.

16. A data transmission method by a computer for transmitting data a destination of which is an apparatus connected via a network via any of a plurality of routes in the network, the method comprising:
referring to a storage unit that stores a usage percentage indicative of a percentage by which each of the plurality of routes is used for transmitting the data the destination of which is the apparatus and distributing the data the destination of which is the apparatus to routes according to the usage percentage of each route to transmit the data the destination of which is the apparatus;
lowering the usage percentage of a route on which a data transmission load is light compared with other routes, the usage percentage being set in the storage unit;
determining, in the case of a state in which usage percentages of two or more routes are greater than a determined value continuing for a determined period of time, that an equilibrium state has arisen; and
setting usage percentages of the two or more routes between which there is a difference in the storage unit in the case of the determination that an equilibrium state has arisen being made.
